(19) United States
(12) Patent Application Publication
(10) Pub. No.: US 2022/0360117 A1
(43) Pub. Date: Nov. 10, 2022

(54) Wireless Power Transfer System and Method

(71) Applicant: Spark Connected LLC, Dallas, TX (US)

(72) Inventors: Petru Emanuel Stingu, Dallas, TX (US); Kenneth Moore, Dallas, TX (US); Malek Ramezani, Lynnwood, WA (US); Ruwanga Dassanayake, Dallas, TX (US)

(21) Appl. No.: 17/732,265

(22) Filed: Apr. 28, 2022

Related U.S. Application Data
(60) Provisional application No. 63/184,666, filed on May 5, 2021.

(51) Int. Cl. H02J 50/80; H02J 50/12; H02M 1/00; H02M 7/219

(52) U.S. Cl. CPC H02J 50/80; H02J 50/12; H02M 1/0058; H02M 7/219

(57) ABSTRACT

A method includes: wirelessly receiving power with a receiver resonant tank from a transmitting coil; rectifying a receiver voltage by switching first and second legs of a synchronous rectifier based on a zero-crossing of a receiver current flowing through the receiver resonant tank to produce a rectified voltage; and while wirelessly receiving power with the receiver resonant tank, encoding data by causing transitions in a transmitter current flowing through the transmitting coil using the synchronous rectifier, where encoding the data includes: applying a first sudden delay period in a first direction to a first switching of the first and second legs to cause a transition in the transmitter current; and applying a first gradual delay in the first direction to subsequent switching of the first and second legs, where the first gradual delay is gradually incremented by an increment period that is smaller than the first sudden delay period.

### CROSS-REFERENCE TO RELATED APPLICATIONS

This application claims the benefit of U.S. Provisional Application No. 63/184,666, filed on May 5, 2021, which application is hereby incorporated herein by reference.

### TECHNICAL FIELD

The present disclosure relates generally to an electronic system and method, and, in particular embodiments, to a wireless power transfer system and method.

### BACKGROUND

Wireless charging systems are becoming ubiquitous in today's society. For example, many smartphones and wearables implement wireless charging technology. Ease of use, greater reliability, spatial freedom, reduced connectors and openings, and the possibility of hermetically sealing are among the benefits offered by wireless charging. Wireless charging standards allow for interoperability between different devices and manufacturers. Some wireless charging standards, such as the Qi standard from the Wireless Power Consortium, and standards promoted by the AirFuel alliance, are becoming widely adopted. The Qi standard uses inductive charging operating between 80 kHz and 300 kHz to wirelessly transmit power from a transmitter to a receiver. Standards promoted by the AirFuel alliance use resonant wireless charging operating at 6.78 MHz to wirelessly transmit power from a transmitter to a receiver.

FIG. 1A shows exemplary wireless charging system 100. Wireless charging system 100 includes a transmitter (TX) device 102 that includes a transmitting coil L_{TX}, and a receiver (RX) device 104 that includes a receiving coil L_{RX}. The efficiency of the wireless power transmission generally depends on the coupling between the coil L_{TX} and coil L_{RX}. The coupling between the coil L_{TX} and coil is generally based on the relative position between the coil L_{TX} and coil L_{RX} .

### SUMMARY

In accordance with an embodiment, a method for transmitting data from a wireless power receiver to a wireless power transmitter includes: wirelessly receiving power with a receiver resonant tank of the wireless power receiver from a transmitting coil of the wireless power transmitter; rectifying a receiver voltage received from the receiver resonant tank by switching first and second legs of a synchronous rectifier circuit based on a zero-crossing of a receiver current flowing through the receiver resonant tank to produce a rectified voltage; and while wirelessly receiving power with the receiver resonant tank, encoding data by causing transitions in a transmitter current flowing through the transmitting coil using the synchronous rectifier circuit, where encoding the data includes: applying a first sudden delay period in a first direction to a first switching of the first and second legs to cause a transition in the transmitter current; and after the first switching of the first and second legs, applying a first gradual delay in the first direction to subsequent switching of the first and second legs, where the first gradual delay is gradually incremented by a gradual increment period that is smaller than the first sudden delay period.

In accordance with an embodiment, a method for transmitting data from a wireless power receiver to a wireless power transmitter includes: wirelessly receiving power with a receiver resonant tank of the wireless power receiver from a transmitting coil of the wireless power transmitter; rectifying a receiver voltage received from the receiver resonant tank by switching first and second legs of a synchronous rectifier circuit based on a zero-crossing of a receiver current flowing through the receiver resonant tank to produce a rectified voltage, where the first leg includes first and second transistors, and where the second leg includes third and fourth transistors; and while wirelessly receiving power with the receiver resonant tank, encoding data by causing transitions in a transmitter current flowing through the transmitting coil using the synchronous rectifier circuit, where encoding the data includes: turning off the first, second, third and fourth transistors for a first sudden period during a first switching cycle of the first and second legs to cause a transition in the transmitter current; and after the first switching cycle, turning off the first, second, third and fourth transistors for a first gradual period during subsequent switching cycles of the first and second legs, where the first gradual period is gradually incremented by a gradual increment period that is smaller than the first sudden period.

In accordance with an embodiment, a method for regulating a rectified voltage includes: wirelessly receiving power with a receiver resonant tank of a wireless power receiver from a transmitting coil of a wireless power transmitter; rectifying a receiver voltage received from the receiver resonant tank by switching first and second legs of a synchronous rectifier circuit based on a zero-crossing of a receiver current flowing through the receiver resonant tank to produce the rectified voltage; and while wirelessly receiving power with the receiver resonant tank, adjusting a phase angle between the first and second legs and the zero-crossing of the receiver current, or between the first and second legs, to regulate the rectified voltage at a target voltage.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A shows an exemplary wireless charging system;

FIG. 1B shows an exemplary bit encoding scheme in accordance with the Qi specification version 1.2.3;

FIG. 2A shows a wireless power receiver, according to an embodiment of the present invention;

FIG. 2B shows waveforms associated with the LC tank of the wireless power receiver of FIG. 2A during active wireless power transfer, according to an embodiment of the present invention;

FIGS. 3A and 3B show a portion of the wireless power receiver of FIG. 2A, and associated waveforms, respectively, according to an embodiment of the present invention;

FIGS. 4A and 4B show a portion of the wireless power receiver of FIG. 2A, and associated waveforms, respectively, according to an embodiment of the present invention;

FIGS. 5A and 5B show a portion of the wireless power receiver of FIG. 2A, and associated waveforms, respectively, according to an embodiment of the present invention;

FIG. 6 shows a flow chart of an embodiment method for communicating from a wireless power receiver to a wireless power transmitter using in-band communication, according to an embodiment of the present invention;

FIGS. 7 and 8 show flow charts of embodiment methods for encoding data using the synchronous rectifier of FIG. 2A, according to embodiments of the present invention;

FIGS. 9A-9C illustrate the switching of the first and second legs of the synchronous rectifier of FIG. 2A at various phase shifts between the switching of the first and second legs and the zero-crossing of receiver current I_{RX}, according to an embodiment of the present invention;

FIG. 10A shows a plots of the rectifier voltage of the wireless power receiver of FIG. 2A versus the phase angle between the switching of the first and second legs and the receiver current, according to an embodiment of the present invention;

FIG. 10B shows a plots of the gain of the wireless power receiver of FIG. 2A versus the phase angle between the switching of the first and second legs and the receiver current, according to an embodiment of the present invention;

FIGS. 11A-11F illustrate the switching of the first and second legs of the synchronous rectifier of FIG. 2A at various phase shifts between the first and second legs, according to an embodiment of the present invention;

FIG. 12A shows a plot of the rectifier voltage of the wireless power receiver of FIG. 2A versus phase angle between the switching of the first and second legs, according to an embodiment of the present invention;

FIG. 12B shows a plot of gain versus phase angle between the switching of the first and second legs of the rectifier voltage of the wireless power receiver of FIG. 2A, according to an embodiment of the present invention;

FIGS. 13 and 14 show flow charts of embodiment methods for regulating a rectified voltage, according to embodiments of the present invention;

FIG. 15 shows a block diagram illustrating two feedback loops for regulating a rectified voltage V_{RX_DC}, according to an embodiment of the present invention;

FIG. 16 shows a block diagram illustrating a feedback loop for regulating a level of transmitted power P_{TX}, according to an embodiment of the present invention;

FIG. 17 shows a flow chart of an embodiment method for regulating a transmitter current I_{TX}, according to an embodiment of the present invention;

FIGS. 18A and 18B show a wireless power receiver, and associated waveforms, respectively, according to an embodiment of the present invention;

FIG. 19 shows waveforms associated with the wireless power receiver of FIG. 18A, according to an embodiment of the present invention; and

FIG. 20 shows waveforms illustrating the resynchronization time of the PLL of FIG. 18A after a change in operating frequency, according to an embodiment of the present invention.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Embodiments of the present invention will be described in a specific context, a wireless power transfer system, method of operation, and method of in-band communication. Some embodiments may be implemented in wired power transfer systems. Some embodiments may comply with one or more wireless power transfer standard such as the Qi standard (e.g., versions 1.0, 1.1, 1.2, 1.2.3, 1.2.4).

It is understood that the term wireless charging is not limited to the charging of a battery, but includes wireless power transmission generally, unless stated otherwise.

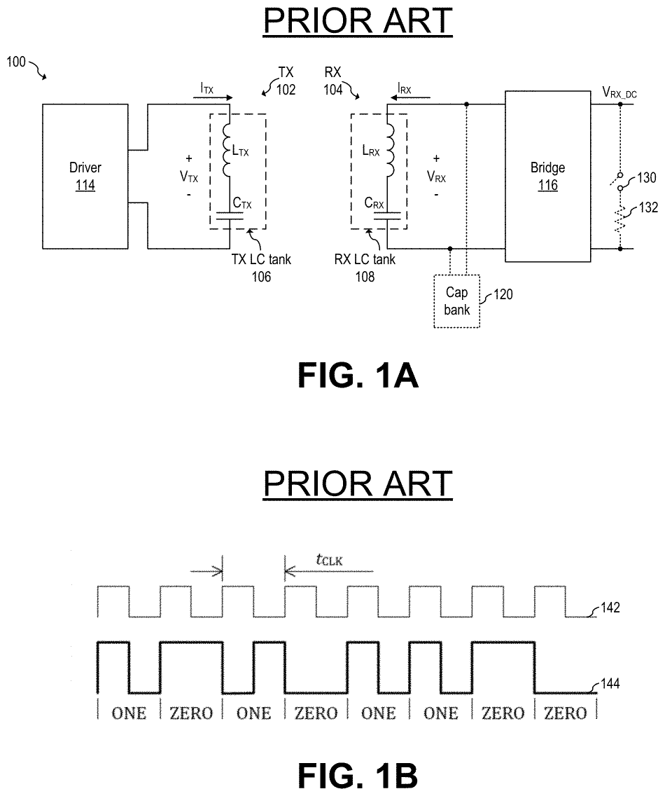

Communication between a wireless power receiver (e.g., 104) and a wireless power transmitter (e.g., 102) is an important aspect of wireless power transfer. Conventional in-band communication between a wireless power receiver and a wireless power transmitter may be performed, e.g., by load modulation at 1 kHz to 2 kHz (e.g., by modulating the amount of power drawn from RX LC tank 108 by using capacitor bank 120 connected to the RX LC tank 108 or resistor 132 and switch 130 connected to the output of bridge 116, as shown in FIG. 1A).

FIG. 1B shows an exemplary bit encoding scheme in accordance with the Qi specification version 1.2.3. Curve 142 shows a clock waveform. Curve 144 illustrates transitions in the current I_{TX}, and the associated bit encoding. As shown, a transition (either from a low state to a high state or from the high state to the low state) occurs at every clock cycle (e.g., at every rising edge of the clock) to delimit each bit. A “ZERO” is encoded as having no additional transitions (no transitions additional to the transitions that delimit the bit). A “ONE” is encoded as having an additional transition between transitions delimiting the bit. Thus, the actual levels for the low level and the high level may not affect the bit encoding. Instead, the location of the transitions between levels (either low to high or high to low) determines the bit encoding.

A transition in current I_{TX} for bit encoding purposes according to the bit encoding scheme illustrated in FIG. 1B may be a transition in which current I_{TX} becomes at least 15 mA higher in a 100 μs period. Thus, wireless power transmitter 102 may detect transitions and decode data by detecting changes in current I_{TX} that are at least 15 mA in magnitude during a 100 μs period. Wireless power transmitter 102 may also detect transitions by detecting a change in voltage V_{TX} that is higher than 200 mV in a 100 μs period.

Data may be transmitted using the bit encoding scheme illustrated in FIG. 1B by connecting and disconnecting capacitors of capacitor bank 120 in a known manner to generate the transitions at appropriate times. Alternatively, data may be transmitted using the bit encoding scheme illustrated in FIG. 1B by activating and deactivating switch 130 in a known manner to generate the transitions at appropriate times.

In an embodiment of the present invention, a wireless power receiver communicates with a wireless power transmitter using in-band communication by performing load modulation with a synchronous rectifier circuit that is coupled to the RX LC tank. By performing the load modulation with the synchronous rectifier circuit, some embodiments advantageously avoid implementing a capacitor bank and/or a resistor for performing load modulation. Thus, some embodiments advantageously achieve a smaller footprint and/or lower costs compared to conventional solutions that rely on a capacitor bank and/or a resistor for load modulation. In some embodiments, the wireless power receiver performs the load modulation in accordance with the Qi standard (e.g., versions 1.0, 1.1, 1.2, 1.2.3, and 1.2.4, for example), thereby advantageously allowing for the reuse of a conventional wireless power transmitter without any hardware or software modifications.

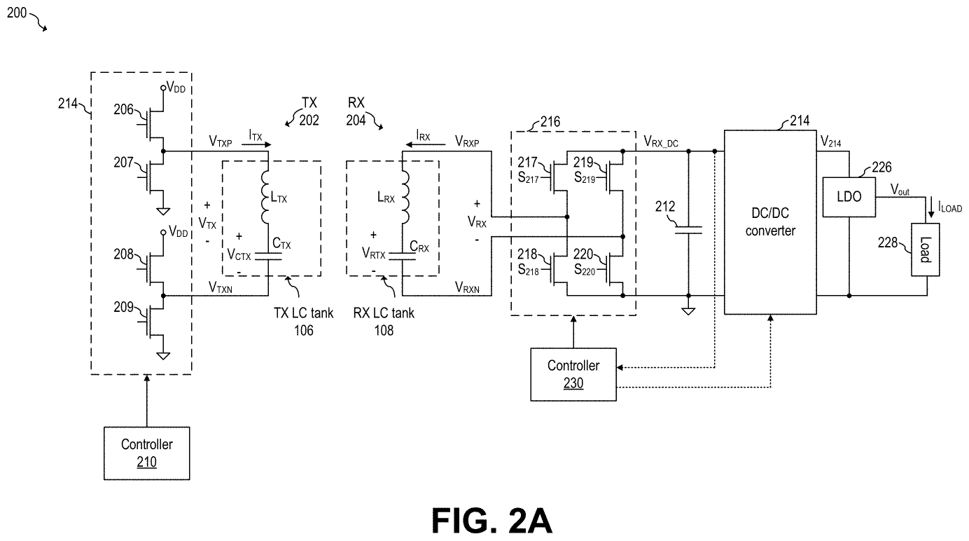

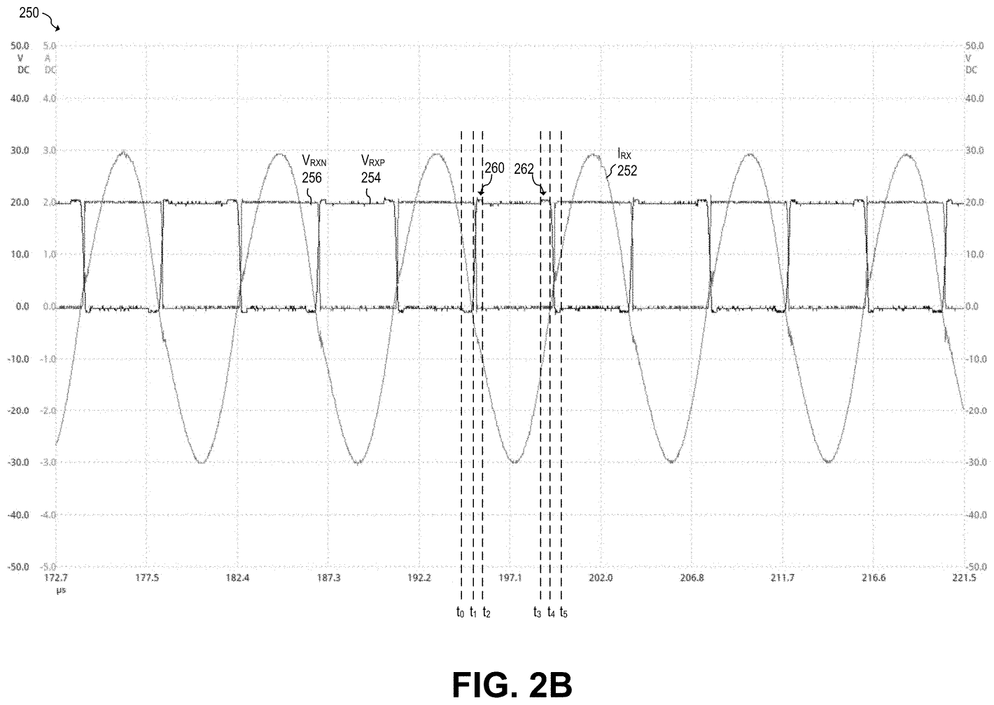

FIG. 2A shows wireless charging system 200, according to an embodiment of the present invention. Wireless charging system 200 includes wireless power transmitter 202 and wireless power receiver 204. Wireless power receiver 204 may be used for in-band communication, according to an embodiment of the present invention.

As shown in FIG. 2A, synchronous rectifier 216 includes a first leg of transistors (transistors 217 and 218) and a second leg of transistors (transistors 219 and 220). In some embodiments, transistors 217 and 218 (and 219 and 220) operate with opposite polarities to avoid shorting node VRX_DC with ground. In some embodiments, there may be times in which all transistors 217, 218, 219, and 220 are off at the same time. In some embodiments, the switching of the first and second legs may overlap for a period of time.

During normal operation, controller 210 controls transistors 206, 207, 208, and 209 to generate a current I_{TX} having a frequency, e.g., between 80 kHz and 300 kHz, such as 127 kHz. The magnetic field generated by transmitting coil L_{TX} as a result of the flow of current I_{TX} induces current I_{Rx} to flow through LC tank 108. Voltage V_{RX} generated across terminals of RX LC tank 108 is rectified by synchronous rectifier 216 to produce rectified voltage V_{RX_DC}. Filtering capacitor 212 may be used to remove fluctuations of voltage V_{RX_DC} at the switching (operating) frequency of the wireless power receiver (e.g., 100 kHz to 300 kHz).

In some embodiments, the rectified voltage V_{RX_DC} is used to power load 228, e.g., via a DC/DC converter 214 followed by LDO 226.

In some embodiments, DC/DC converter 214 may be implemented as a boost, buck-boost, or buck converter. Other implementations, such as a fly-back converter, as well as capacitive charge-pump/voltage dividers may also be used. In some embodiments, DC/DC converter 214 may operate in a non-switching mode (e.g., in bypass mode) during periods of times during normal operation. In some embodiments, DC/DC converter 214 may be omitted. In some embodiments, LDO 228 may be omitted. In some embodiments, converter 214 and LDO 228 may be omitted.

Load 228 may be, e.g., a custom or general purpose microcontroller, a battery charger, or other electronic circuit, such as other digital, analog, or mixed signal circuit, such as amplifiers, power management circuits, audio circuits, etc. For example, in some embodiments, load 228 is a power converter, e.g., for powering other circuits.

LDO 226 may be implemented in any way known in the art, such as by using a regulation transistor to couple voltage V₂₁₄ to voltage Vₒᵤₜ, and an amplifier in a feedback network that senses output voltage Vₒᵤₜ and controls the control terminal of the regulation transistor to provide a regulated output voltage Vₒᵤₜ. Other implementations are possible.

In some embodiments, other converters may be used instead of, or in addition to LDO 226. For example, in some embodiments, a switching regulator may be used instead of LDO 226. In some embodiments, voltage V₂₁₄ is provided directly to load 228 without an intervening power converter.

In some embodiments, controller 230 is used to control synchronous rectifier 216 to produce rectified voltage V_{RX_DC} from voltage V_{RX}. Controller 230 may be implemented, e.g., as a general purpose or custom microcontroller including combinatorial logic coupled to a memory. Other implementations are also possible.

In some embodiments, controller 210 is used to control driver 214. Controller 210 may be implemented, e.g., as a general purpose or custom microcontroller including combinatorial logic coupled to a memory. Other implementations are also possible.

In some embodiments, filtering capacitor 212 may have a capacitance of, e.g., 100 μF. Other capacitances, such as higher than 100 μF (e.g., 150 μF or more) or lower than 100 μF (e.g., 20 μF or less) may also be used.

FIG. 2B shows waveforms 250 associated with LC tank 108 of wireless power receiver 204 during active wireless power transfer, according to an embodiment of the present invention. Waveforms 250 include curves 252, which corresponds to receiver current I_{RX} flowing through RX LC tank 108, and curves 254 and 256, which corresponds to voltages V_{RXP} and V_{RXN}, respectively, across RX LC tank 108. In this example, voltages V_{RXP} and V_{RXN} are measured with respect to the ground reference on the DC side of synchronous rectifier 216.

During normal operation, as shown in FIG. 2B, synchronous rectifier 216 switches transistors 217, 218, 219, and 220 when receiver current I_{RX} is around the zero-crossing point. For example, immediately before time t₁, transistors 218 and 219 are on, transistors 217 and 220 are off, and current I_{RX} is positive (flowing from node V_{RXP} into RX LC tank 108). At time t₁ (at the zero crossing of I_{RX}, transistors 218 and 219 turn off, and the receiver current I_{RX} turning negative (flowing from RX LC tank 108 into node V_{RXP}) causes voltages V_{RXP} and V_{RXN} to flip. At time t₂, transistors 217 and 220 are turned on, thereby avoiding the diode drop across transistor 217 and 220 (which causes voltage V_{RXP} to be higher during portion 260, than between times t₂ and t₃). At time t₃, transistors 217 and 220 are turned off, and the receiver current I_{RX} turning positive causes voltages V_{RXP} and V_{RXN} to flip. At time t₄, transistors 218 and 219 are turned on.

As shown in FIG. 2B, in some embodiments, the diode drop associated with V_{RXN} during portions 260 and 262 is very short (e.g., the dead-time may be about 50 ns, which may be seen as a very short glitch). Thus, in some embodiments, the dead-time is applied only with respect to voltage V_{RXP} (e.g., by having transistors 217 and 218 off during portion 260 and 262). In some embodiments, dead-times longer than 50 ns (e.g., 500 ns or more) may be applied such that a diode drop is seen in both V_{RXP} and V_{RXN}.

In some embodiments, wireless power receiver 204 performs load modulation for in-band communication by adding and removing energy from filtering capacitor 212 using synchronous rectifier 216. In some embodiments, the load modulation for in-band communication is performed according to the bit encoding scheme illustrated in FIG. 1B. In some embodiments, the load modulation for in-band communication is performed at a frequency between 1 kHz and 2 kHz.

In some embodiments, energy is added to filtering capacitor 212 or removed from filtering capacitor 212 by phase shifting the switching time of synchronous rectifier 216 with respect to current I_{RX}. In some embodiments, energy is added to filtering capacitor 212 or removed from filtering capacitor 212 by phase shifting the switching time of the first/second leg with respect to the second/first leg. In some embodiments, phase shifting the switching of the first/second leg with respect to the second/first leg or with respect to the zero-crossing of current I_{RX} advantageously causes an impedance change (as seen from wireless power transmitter 202), which causes a transition in current I_{TX}. In some embodiments, the timing of such transitions can be monitored to receive data via TX LC tank 106. The received data may be decoded, e.g., with respect to a reference clock (e.g., available to wireless power transmitter 102). In some embodiments, the impedance, as seen from wireless power transmitter 202, is changed to cause transitions in current I_{TX} by adjusting the magnitude of dead-times during synchronous rectification. In some embodiments, wireless power transmitter 202 reconstructs the reference clock (e.g., 142) in a known manner based on edges/zero crossings in the demodulated signal (e.g., current I_{TX} after filtering).

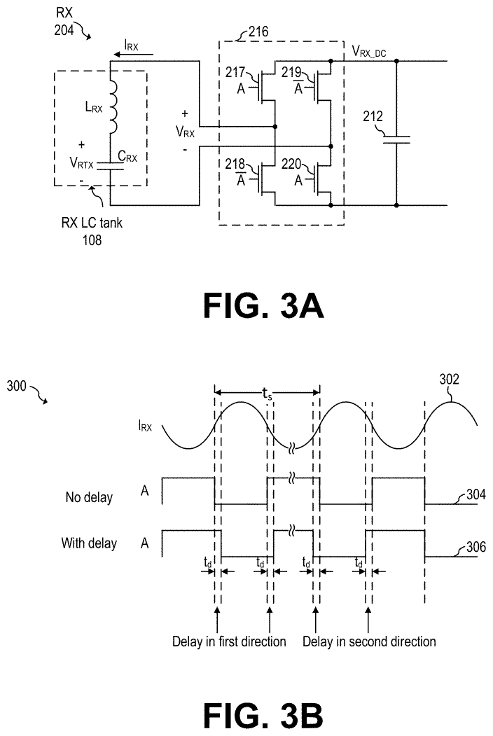

In an embodiment, energy is added to filtering capacitor 212 or removed from filtering capacitor 212 by (e.g., monotonically) increasing delay times t_{d} with respect to current I_{RX} in a first or second direction, respectively, over the data transmission period. For example, FIGS. 3A and 3B show a portion of wireless power receiver 204, and associated waveforms 300, respectively, according to an embodiment of the present invention. For simplicity, waveforms 300 assume a dead-time of zero and avoid showing other practical details of synchronous rectification. Some embodiments may exhibit dead-times higher than zero, such as constant dead-times or varying dead-times.

Curve 302 shows current I_{RX} corresponding to no delay being applied to the driving signals of synchronous rectifier 216 (e.g., with respect to curve 304). Curve 304 shows driving signal A for driving of transistors 217 and 220 for conventional synchronous rectification (with no delay being applied with respect to current I_{RX}. Curve 306 shows driving signal A for driving transistor 217, and 220 for transmitting data in-band using switching delays between the first and second legs with respect to the zero-crossing of current I_{RX}, according to an embodiment of the present invention. Driving signal Ā for driving transistors 218 and 219 has opposite phase as signal A.

As illustrated in FIG. 3A, in some embodiments, transistors 217 and 219 may not be in the same state (e.g., both on or both off) simultaneously. Similarly, in some embodiments, transistors 218 and 220 may not be in the same state (e.g., both on or both off) simultaneously.

As shown by curve 306, delay t_{d} may be added in a first direction (e.g., positive delay) or in a second direction (e.g., negative delay). Adding positive delays t_{d} with respect to the zero-crossing of current I_{RX} causes voltage on capacitor 212 to increase. Adding negative delays t_{d} with respect to the zero-crossing of current I_{RX} causes voltage on capacitor 212 to decrease.

In some embodiments, adding (e.g., with respect to the zero crossing of current I_{RX} or with respect to the last switching phase of synchronous rectifier circuit 216) a sudden positive delay (e.g., from 0 ns to 100 ns) or a sudden negative delay (e.g., from 0 ns to 100 ns) causes a transition (e.g., from a high/low level to a low/high level) in current I_{TX} that may be used to encode data (e.g., in accordance to the bit encoding scheme illustrated in FIG. 1B). For example, in some embodiments, a sudden delay t_{d} may be added each time a transition in current I_{TX} is desired for bit encoding purposes. In some embodiments, the direction of the sudden delay t_{d} (positive or negative) is alternated each time a transition in current I_{TX} is desired, which may advantageously allow for keeping the average switching of synchronous rectifier 216 centered around the zero-crossing of current I_{RX}.

In some embodiments, sudden delays t_{d} are applied at a frequency between 1 kHz and 2 kHz.

In some embodiments, once a sudden (e.g., positive or negative) delay t_{d} is applied (causing a transition in current I_{TX}) the delay t_{d} for subsequent switching cycles of the first and second legs is gradually incremented in the same direction (e.g., at a constant rate) to avoid additional undesired transitions in current I_{TX} (e.g., avoid transitions in current I_{TX} higher than 15 mA in a 100 μs period or avoid a transition in voltage V_{TX} that is higher than 200 mV in a 100 μs period). In some embodiments, the gradually incrementing the delay t_{d} after the application of a sudden delay t_{d} includes incrementing the delay t_{d} at a rate that is lower than 50% of the rate of the sudden delay t_{d}. For example, if a sudden delay t_{d} from 0 ns to 100 ns is applied in the first direction (positive delay), the gradually incrementing of the delay t_{d} includes that for the next switching cycles, the delay t_{d} is incremented in steps of 10 ns (e.g., 110 ns, 120 ns, 130 ns, etc.) until the next transition in current I_{TX} is desired.

In some embodiments, the sudden delay t_{d} may include a delay step between 10 ns to 500 ns (where time t_{d} of the preceding switching was 10 ns and is 500 ns in the current switching). In some embodiments, the sudden delay t_{d} may have other magnitudes.

In some embodiments, the delay t_{d} is gradually adjusted during each switching transition of the first and second leg in the same direction (e.g., every other zero-crossing of current I_{RX}. In some embodiments, the delay t_{d} is gradually adjusted during each switching transition of the first and second legs (e.g., every zero-crossing of current I_{RX}. Other adjustment timings are also possible.

In some embodiments, avoiding additional undesired transitions may be achieved by incrementing the gradual delay t_{d}, after the sudden delay t_{d}, at a constant rate, and in the same direction as the sudden delay. In some embodiments, avoiding additional undesired transitions may be achieved by monitoring voltage V_{RX_DC} and causing a gradual (e.g., monotonic, e.g., linear) change in (e.g., RMS, average) voltage V_{RX_DC} (e.g., in the same direction as the change caused by the sudden delay), by dynamically adjusting the magnitude of the delay t_{d}. In some embodiments, controller 230 may receive an indication of the magnitude of voltage V_{RX_DC} (e.g., via an ADC or analog circuit, such as using an op-amp, in a way known in the art) and may control the magnitude of the delay to cause the gradual change in voltage V_{RX_DC} . Thus, in some embodiments, the RMS voltage of V_{RX_DC} increases (e.g., linearly) from an initial voltage (e.g., corresponding to a voltage with immediately after application of the sudden delay t_{d}) to a higher voltage (e.g., until a time in which a next sudden transition in current I_{TX} is caused). In some embodiments, the rate of change of voltage V_{RX_DC} during the gradual change period is (e.g., constant and) less than 50% of the voltage change caused by the application of the sudden delay.

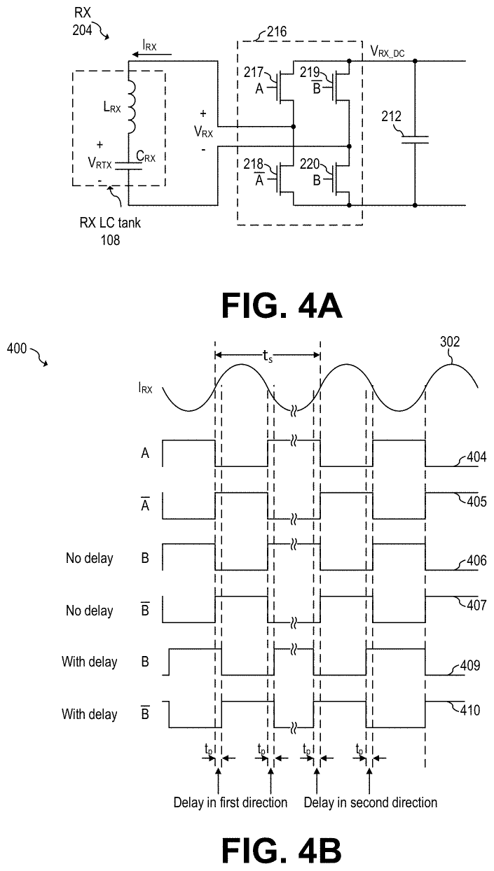

In an embodiment, energy is added to filtering capacitor 212 or removed from filtering capacitor 212 by (e.g., monotonically) increasing delay times tₚ between the first and second legs in a first or second direction, respectively, over the data transmission period. For example, FIGS. 4A and 4B show a portion of wireless power receiver 204, and associated waveforms 400, respectively, according to an embodiment of the present invention. For simplicity, waveforms 400 assume a dead-time of zero and avoid showing other practical details of synchronous rectification. Some embodiments may exhibit dead-times higher than zero, such as constant dead-times or varying dead-times.

Curves 404 and 405 show driving signals A and Ā for driving transistors 217 and 218 218, respectively, for conventional synchronous rectification (with no delay being applied with respect to current I_{RX}). Curves 406 and 407 show driving signals B and B̅ for driving transistors 220 and 219, respectively, for conventional synchronous rectification (with no delay being applied with respect the first and second legs). Curves 408 and 409 show driving signals B and B̅ for driving transistors 220 and 219, respectively, for transmitting data in-band using switching delays between the first and second legs, according to an embodiment of the present invention.

As illustrated in FIG. 4B, some embodiments, may switch one of the legs at the zero-crossing of current IRX while varying the switching phase of the other leg. In some embodiments, the switching times of both the first and second legs may be simultaneously adjusted to alter the phase between the first and second legs.

As illustrated in FIGS. 4A and 4B, in some embodiments, transistors 217 and 219 may both be in the same state (e.g., both on or both off) simultaneously (e.g., during period tₚ). Similarly, in some embodiments, transistors 218 and 220 may both be in the same state (e.g., both on or both off) simultaneously (e.g., during period tₚ).

As shown by curves 409 and 410, delay tₚ may be added in a first direction (e.g., positive delay) or in a second direction (e.g., negative delay). Adding positive delays tₚ to the switching of the second leg with respect to the switching of the first leg causes voltage on capacitor 212 to increase. Adding negative delays tₚ to the switching of the second leg with respect to the switching of the first leg causes voltage on capacitor 212, thereby charging capacitor 212 to decrease. In some embodiments, depending on the operating point for the voltage/current phase shift, the phase shift between legs may cause inverted effects (e.g., the voltage on capacitor 212 may increase for negative changes in phase).

In some embodiments, adding a sudden positive delay (e.g., from 0 ns to 100 ns) or a sudden negative delay (e.g., from 0 ns to 100 ns) to the second leg with respect to the first leg causes a transition (e.g., from a high/low level to a low/high level) in current I_{TX} that may be used to encode data (e.g., in accordance to the bit encoding scheme illustrated in FIG. 1B). For example, in some embodiments, a sudden delay tₚ to the switching of the second leg with respect to the first leg may be added each time a transition in current I_{TX} is desired for bit encoding purposes. In some embodiments, the direction of the sudden delay tₚ (positive or negative) is alternated each time a transition in current I_{TX} is desired, which may advantageously allow for keeping the average switching phase between the first and second legs centered around 0°.

In some embodiments, sudden delays tₚ are applied at a frequency between 1 kHz and 2 kHz.

In some embodiments, once a sudden (e.g., positive or negative) delay tₚ is applied (causing a transition in current I_{TX}) the delay tₚ for subsequent switching cycles of the first and second legs is gradually incremented in the same direction (e.g., at a constant rate) to avoid additional undesired transitions in current I_{TX} (e.g., avoid transitions in current I_{TX} higher than 15 mA in a 100 μs period or avoid a transition in voltage V_{TX} that is higher than 200 mV in a 100 μs period). In some embodiments, the gradually incrementing the delay tₚ after the application of a sudden delay tₚ includes incrementing the delay at a rate that is lower than 50% of the rate of the sudden delay. For example, if a sudden delay from 0 ns to 100 ns is applied in the first direction (positive delay), the gradually incrementing of the delay tₚ may cause that for the next switching cycles, the delay is incremented in steps of 10 ns (e.g., 110 ns, 120 ns, 130 ns, etc.) until the next transition in current I_{TX} is desired.

In some embodiments, the sudden delay tₚ may include a delay step between 10 ns to 500 ns (where time t_{d} of the preceding switching was 10 ns and is 500 ns in the current switching). In some embodiments, the sudden delay tₚ may have other magnitudes.

In some embodiments, the delay tₚ is gradually adjusted during each switching transition of the first and second leg in the same direction (e.g., every other zero-crossing of current I_{RX}. In some embodiments, the delay tₚ is gradually adjusted during each switching transition of the first and second legs (e.g., every zero-crossing of current I_{RX}). Other adjustment timings are also possible.

In some embodiments, avoiding additional undesired transitions may be achieved by incrementing the gradual delay tₚ, after the sudden delay tₚ, at a constant rate, and in the same direction as the sudden delay. In some embodiments, avoiding additional undesired transitions may be achieved by monitoring voltage V_{RX_DC} and causing a gradual (e.g., monotonic, e.g., linear) change in (e.g., RMS, average) voltage V_{RX_DC} (e.g., in the same direction as the change caused by the sudden delay), by dynamically adjusting the magnitude of the delay tₚ. In some embodiments, controller 230 may receive an indication of the magnitude of voltage V_{RX_DC} (e.g., via an ADC or analog circuit, such as using an op-amp, in a way known in the art) and may control the magnitude of the delay to cause the gradual change in voltage V_{RX_DC} . Thus, in some embodiments, the RMS voltage of V_{RX_DC} increases (e.g., linearly) from an initial voltage (e.g., corresponding to a voltage with immediately after application of the sudden delay tₚ) to a higher voltage (e.g., until a time in which a next sudden transition in current I_{TX} is caused). In some embodiments, the rate of change of voltage V_{RX_DC} during the gradual change period is (e.g., constant and) less than 10% of the voltage change caused by the application of the sudden delay.

In some embodiments, after application of a sudden delay to the switching of the first and second legs (e.g., with respect to current I_{RX} (t_{d}) or with respect to the other leg (tₚ)) voltage V_{RX_DC} is at least V_{RX_DC_thres} higher or at least V_{RX_DC_thres} lower than before application of the sudden delay. In some embodiments, V_{RX_DC_thres} is 5%. In some embodiments, V_{RX_DC_thres} may be higher than 5%, such as 6%, 9% or more. In some embodiments, V_{RX_DC_thres} may be lower than 5%, such as 4%, 2% or lower.

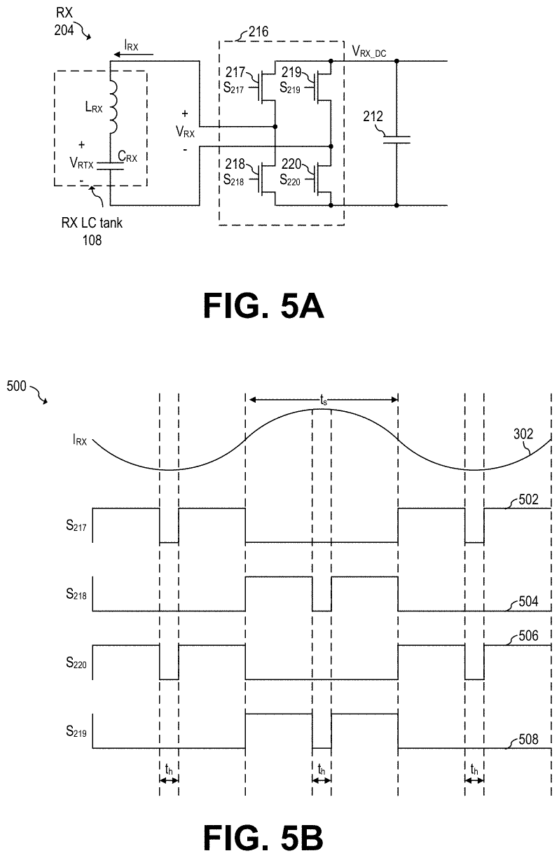

In an embodiment, transitions in current I_{TX} for encoding data are caused changing the impedance seen by the wireless power transmitter by (e.g., monotonically) increasing or decreasing dead-times over the data transmission period. For example, FIGS. 5A and 5B show a portion of wireless power receiver 204, and associated waveforms 500, respectively, according to an embodiment of the present invention. For simplicity, waveforms 500 assume a dead-time of zero around the zero-crossing of current I_{RX} and avoid showing other practical details of synchronous rectification.

As shown in FIGS. 5A and 5B, transistors 217, 218, 219, and 220 are all off for a period tₕ (also referred to as a switching dead-time period) when current I_{RX} is relatively high (e.g., higher than 70% of the peak of current I_{RX}. During period tₕ, wireless power transmitter 202 is active and actively transmitting wireless power. By turning off transistors 217, 218, 219, and 220 during time t_{h,} rectifier 216 temporarily changes (during period tₕ) from operating using active rectification to operating as a passive rectifier (via body diodes). Such change causes a change in impedance, as seen by wireless power transmitter 202, which may be reflected as a change in current I_{TX}.

In some embodiments, period tₕ may be applied around the zero-crossing of current I_{RX}. For example, in some embodiments, transistors 217, 218, 219, and 220 are turned off at the zero-crossing (or slightly before, or slightly after) of current I_{RX} and remain off for the period tₕ. In some embodiments, causing the dead-time to occur around the zero-crossing of current I_{RX} advantageously allows for a change in operating mode of rectifier (from active rectification to passive rectification) while avoiding hard switching transistors 217, 218, 219, and 220.

In some embodiments, period tₕ may be lower than 1 μs, such as, e.g., 50 ns. Other values are also possible.

In some embodiments, changing the duration of period tₕ causes a change in impedance, as seen by wireless power transmitter 202. In some embodiments, applying a sudden change (e.g., increase or decrease) in period tₕ (e.g., from 0 ns duration to 100 ns duration or from 100 ns duration to 50 ns duration) causes a transition (e.g., from a high/low level to a low/high level) in current I_{TX} that may be used to encode data (e.g., in accordance to the bit encoding scheme illustrated in FIG. 1B). For example, in some embodiments, a sudden change in period tₕ may be applied each time a transition in current I_{TX} is desired for bit encoding purposes. In some embodiments, the direction of the sudden change in period tₕ (increase or decrease) is alternated each time a transition in current I_{TX} is desired, which may advantageously allow for keeping (e.g., the RMS value) of voltage V_{RX_DC} constant.

In some embodiments, sudden changes in period tₕ are applied at a frequency between 1 kHz and 2 kHz.

In some embodiments, once a sudden (e.g., increase or decrease) change in period tₕ is applied (causing a transition in current I_{TX}) the period tₕ is gradually changed (e.g., increased/decreased) in the same direction (e.g., at a constant rate) to avoid additional undesired transitions in current I_{TX} (e.g., avoid transitions in current I_{TX} higher than 15 mA in a 100 μs period or avoid a transition in voltage V_{TX} that is higher than 200 mV in a 100 μs period). In some embodiments, the gradual change in duration of period tₕ after the application of a sudden change in duration of period tₕ includes incrementing/decrementing the duration of period tₕ at a rate that is lower than 50% of the rate of the sudden change in duration of period tₕ. For example, if a sudden change in duration of period tₕ involves increasing the duration of period tₕ from 0 ns to 100 ns, the gradual incrementing of the period tₕ may cause that for the next switching cycles, the duration of period tₕ is incremented in steps of 10 ns (e.g., 110 ns, 120 ns, 130 ns, etc.) until the next transition in current I_{TX} is desired. In some embodiments, modulation of period th causes a temporary drop in voltage in capacitor 212.

In some embodiments, the sudden change in period tₕ may include a duration change between 100 ns to 50 ns. In some embodiments, the duration of the sudden change in period tₕ may be lower than 50 ns or higher than 100 ns.

In some embodiments, avoiding additional undesired transitions may be achieved by changing the duration of period tₕ, after the sudden change in duration of period tₕ, at a constant rate, and in the same direction as the sudden change in duration of period tₕ. In some embodiments, avoiding additional undesired transitions may be achieved by monitoring voltage V_{RX_DC} and causing a gradual (e.g., monotonic, e.g., linear) change in (e.g., RMS) voltage V_{RX_DC} (e.g., in the same direction as the change caused by the sudden delay), by dynamically adjusting the duration of period tₕ. In some embodiments, controller 230 may receive an indication of the magnitude of voltage V_{RX_DC} (e.g., via an ADC) and may control the duration of period tₕ to cause the gradual change in voltage V_{RX_DC} . Thus, in some embodiments, the RMS voltage of V_{RX_DC} increases (e.g., linearly) from an initial voltage (e.g., corresponding to a voltage with immediately after application of the sudden delay) to a higher voltage (e.g., until a time in which a next sudden transition in current I_{TX} is caused). In some embodiments, the rate of change of voltage V_{RX_DC} during the gradual change period is (e.g., constant and) less than 10% of the voltage change caused by the application of the sudden delay.

In some embodiments, the data transmission rate is many times lower than the switching frequency of wireless power receiver 204, such as 40 times lower or more. For example, in an embodiment, the data transmission rate is 2 kHz and the switching frequency of wireless power receiver 204 is 127 kHz. Other frequencies may also be used.

Advantages of some embodiments include that, by using the synchronous rectifier circuit to cause sudden changes in the impedance (e.g., causing a sudden change in voltage V_{RX_DC}), as seen by the wireless power transmitter, to cause an associated transition in current I_{TX}, and by keeping constant the rate of change of the impedance (e.g., the rate of change in voltage V_{RX_DC}) when transitions in current I_{TX} are undesired, some embodiments advantageously encode data for a wireless power transmitter in compliance with the Qi standard (e.g., versions 1.0, 1.1, 1.2, 1.2.3, 1.2.4) without using a capacitor bank (e.g., 120) or resistor switching (e.g., 130, 132). Thus, some embodiments, advantageously allows for a conventional wireless power transmitter operating in accordance with the Qi standard (e.g., versions 1.0, 1.1, 1.2, 1.2.3, 1.2.4) to successfully demodulate the data transmitted by wireless power receiver 204, e.g., by using analog or digital filtering to extract data from the voltage across coil L_{TX}, e.g., encoded using amplitude-shift keying (ASK), phase-shift-keying (PSK) or load modulation in general (combination of ASK and PSK).

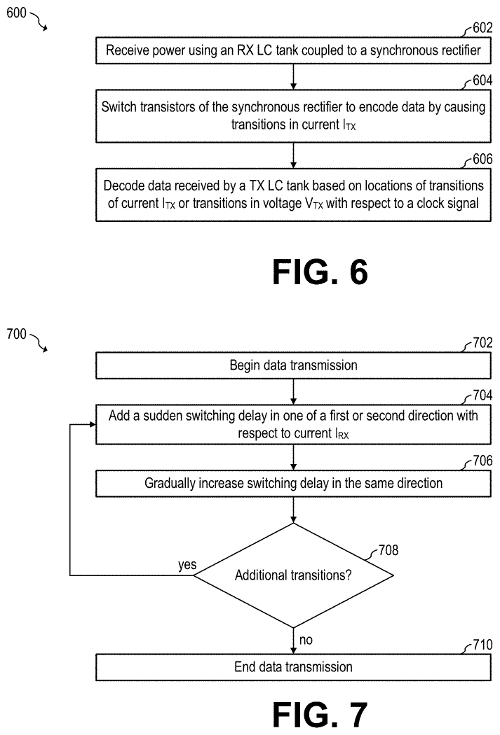

FIG. 6 shows a flow chart of embodiment method 600 for communicating from a wireless power receiver to a wireless power transmitter using in-band communication, according to an embodiment of the present invention. In some embodiments, the wireless power receiver used in method 600 may be implemented as wireless power receiver 204. In some embodiments, the wireless power transmitter used in method 600 may be implemented as a conventional wireless power transmitter (e.g., 102) that complies with the Qi standard (e.g., versions 1.0, 1.1, 1.2, 1.2.3, 1.2.4).

During step 602, an RX LC tank (e.g., 108) of a wireless power receiver (e.g., 204) receives power from a transmitting coil L_{TX} of a wireless power transmitter (e.g., 102, 202).

During step 604, while receiving power, the transistors (e.g., 217, 218, 219, and 220) are controlled so as to cause a transition in current I_{TX} from a first level (e.g., low/high) to a second level (e.g., high/low) to encode data based on the time location of the transitions (e.g., in accordance with the bit encoding scheme illustrated in FIG. 1B). In some embodiments, the transitions occur at a frequency between 1 kHz and 2 kHz.

During step 606, data is decoded by the wireless power transmitter by determining the location of transitions in current I_{TX} or voltage V_{TX} with respect to a clock signal (e.g., in accordance with the bit encoding scheme illustrated in FIG. 1B). In some embodiments, wireless power transmitter 202 reconstructs the reference clock (e.g., 142) in a known manner based on edges/zero crossings in the demodulated signal (e.g., current I_{TX} after filtering).

In some embodiments, the wireless power transmitter is a conventional wireless power transmitter complying with the Qi standard (e.g., versions 1.0, 1.1, 1.2, 1.2.3, 1.2.4). In some embodiments, the wireless power transmitter identifies a transition in current I_{TX} when current I_{TX} exhibits a change of at least 15 mA in a 100 μs period. In some embodiments, the wireless power transmitter identifies a transition in voltage V_{TX} when voltage V_{TX} exhibits a change of at least 200 mV in a 100 μs period.

FIG. 7 shows a flow chart of embodiment method 700 for encoding data using synchronous rectifier 216, according to an embodiment of the present invention. Step 604 may be implemented as method 700.

During step 702, data transmission begins. In some embodiments, the data transmitted is encoded in bytes having 11 bits including a start event (e.g., a start bit of 0) followed by 8 bits, follows by a parity bit, followed by a stop event (e.g., a single bit of 1). In some embodiments, the data transmitted bytes are arranged in packets having a format including a preamble, followed by a header, followed by a message, and the followed by a checksum.

During step 704, a sudden switching delay (e.g., t_{d} or tₚ) is added to the switching of the first and/or second legs in a first (e.g., positive delay) or second (e.g., negative delay) direction with respect to the zero-crossing of current I_{RX} or with respect to the other leg to cause a transition in current I_{TX}.

During step 706, the switching delay is gradually increased in the same direction as the previously applied switching sudden delay. If during step 708 it is determined that additional transitions in current I_{TX} are desired, e.g., to properly encode the data (e.g., in accordance with a selected encoding scheme), then step 704 is repeated. Otherwise, the data transmission ends.

In some embodiments, each time step 704 is performed during the same data transmission event, the direction of the sudden switching delay applied is toggled. For example, in some embodiments, a first sudden switching delay t_{d} (and/or tₚ) is applied (during step 704) that increases the delay from 0 ns to 50 ns. After gradually increasing (during step 706) the switching delay t_{d} (and/or tₚ) in a first direction up to a higher switching delay (e.g., 60 ns), a sudden switching delay t_{d} (and/or tₚ) in a second direction is applied. In some embodiments, the second sudden delay may cause a change in switching delay with respect to the zero-crossing of current I_{RX}, e.g., from 60 ns delay to −50 ns delay (which then gradually increases to, e.g., −60 ns) until the next time step 604 is executed. In some embodiments, the second sudden delay may cause a change in switching delay with respect to the previous switching time, e.g., from 60 ns to 10 ns, and then gradually increasing in the same second direction up to a lower switching delay (e.g., −10 ns). In some embodiments, the delays in the first and second directions are symmetric. In some embodiments, the symmetric delays are centered at the zero-crossing of current I_{RX}.

In some embodiments, step 704 is performed at a frequency between 1 kHz and 2 kHz.

Some embodiments may adjust delay time t_{d} with respect to zero-crossing of current I_{RX} and not delay time tₚ between the first and second legs during steps 704 and 706. Some embodiments may adjust delay time t delay time tₚ between the first and second legs, and not adjust delay time t_{d} with respect to zero-crossing of current I_{RX} during steps 704 and 706. Some embodiments may adjust both delay time t_{d} with respect to zero-crossing of current I_{RX} and delay time tₚ between the first and second legs during steps 704 and 706.

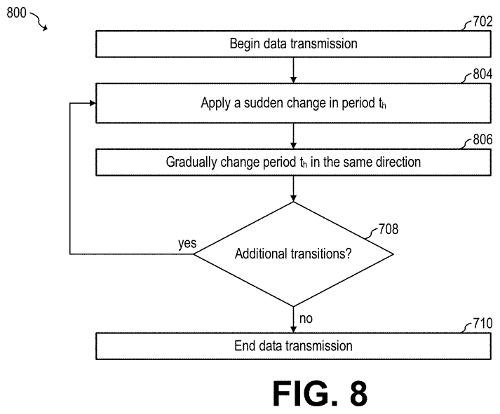

FIG. 8 shows a flow chart of embodiment method 800 for encoding data using synchronous rectifier 216, according to an embodiment of the present invention. Step 604 may be implemented as method 800. Method 800 includes steps 702, 804, 806, 708 and 610. Steps 602, 608, and 610 may be performed in a similar manner as in method 600.

During step 804, a sudden switching dead-time period (e.g., tₕ) is applied in a first (e.g., increasing) or second (e.g., decreasing) direction. For example, in some embodiments, the sudden change in switching dead-time period causes all transistors to be off for a period of, e.g., 50 ns during each switching cycle (from 0 ns).

During step 806, the switching dead-time period is gradually changed (increased/decreased) in the same direction as the previously applied sudden switching dead-time period. For example, in some embodiments, if the sudden switching dead-time period increased from 0 ns to 50 ns, the gradual change during step 806 is a gradual increment of the switching dead-time period from 50 ns up to a higher dead-time period (e.g., 60 ns). In some embodiments, if the sudden switching dead-time period decreased from 60 ns to 30 ns, the gradual change during step 806 is a gradual decrease of the switching dead-time period from 30 ns up to a lower dead-time period (e.g., 20 ns).

In some embodiments, steps 704 and 804 may be performed during the same data transfer process. For example, a method for encoding data using synchronous rectifier 216 may include sequentially performing steps 702, 704, 706, 708, 804, 806, 708, 704, 706 , 708 , 704, 706, 708, 804, 806, 708, 804, 806, 708, . . . , 710.

In an embodiment of the present invention, a wireless power receiver (e.g., 204) regulates the rectified voltage (e.g., V_{RX_DC}) by modulating the switching times of a synchronous rectifier (e.g., 216) coupled to the receiver LC tank (e.g., 108). In some embodiments, the timing of the switching of the first and second legs of the synchronous rectifier is modulated with respect to a zero-crossing of a rectifier current (I_{RX}) flowing through the receiver LC tank (e.g., as illustrated in FIG. 3B) to regulate the rectified voltage to a target voltage. In some embodiments, the timing of the switching of the first and second legs of the synchronous rectifier is modulated with respect to each other (e.g., as illustrated in FIG. 4B) to regulate the rectified voltage to a target voltage.

By regulating the rectified voltage using the synchronous rectifier, some embodiments advantageously achieve fast and improved load transient response, e.g., when the load (e.g., 228) suddenly changes. In some embodiments, such fast load transient response may occur before the wireless power transmitter (e.g., 202) has adjust the power transmitted in response to data received from the wireless power receiver (e.g., 204) via in-band communication. In some embodiments, the regulation of the rectified voltage is only active (e.g., actively modulating the switching times of the synchronous rectifier) during load transient, and becomes inactive (no switching time delays with respect to a switching time of a conventional synchronous rectifier) once the wireless power transmitter adjusts the transmitted power.

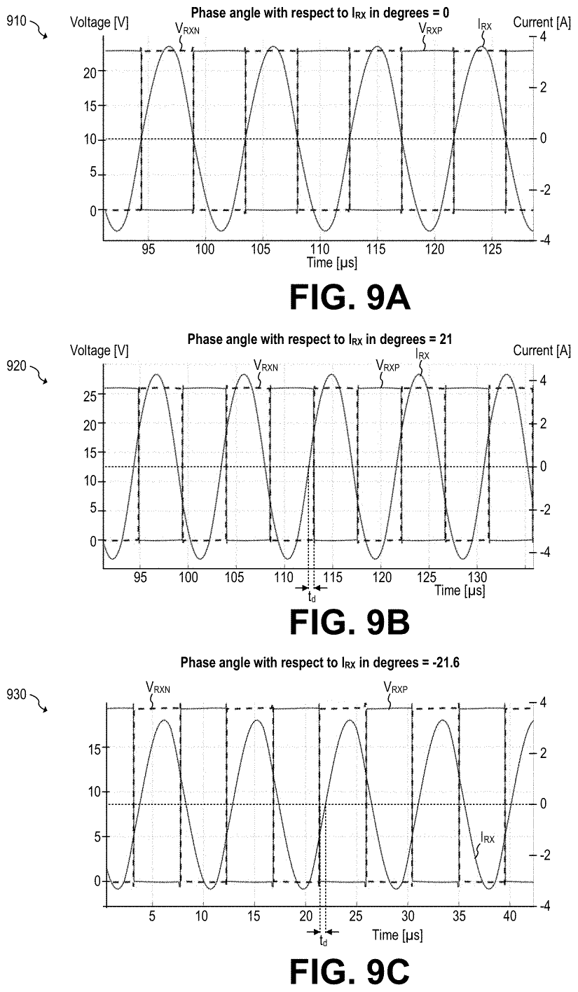

In some embodiments, wireless power receiver 204 regulates the rectified voltage V_{RX_DC} by removing or adding energy to capacitor 212 using synchronous rectifier 216. For example, in some embodiments, adding a fixed positive delay time t_{d} over a plurality of switching cycles of synchronous rectifier 216 causes voltage V_{RX_DC} to settle into a new voltage higher than without applying the fixed positive delay (as can be seen from FIG. 9B). Thus, some embodiments are capable of operating as a step-up (e.g., boost) converter by applying positive delays to the switching of the first and second legs of synchronous rectifier circuit 216 with respect to the current I_{RX}.

In some embodiments, adding a fixed negative delay time t_{d} over a plurality of switching cycles of synchronous rectifier 216 causes voltage V_{RX_DC} to settle into a new voltage lower than without applying the fixed negative delay (as can be seen from FIG. 9C). Thus, some embodiments are capable of operating as a step-down (e.g., buck) converter by applying negative delays to the switching of the first and second legs of synchronous rectifier circuit 216 with respect to the current I_{RX}.

Some embodiments may regulate voltage V_{RX_DC} to a target voltage by applying positive and negative delays (t_{d}) to the switching of the first and second legs with respect to the zero-crossing of current I_{RX}.

FIGS. 9A-9C illustrate the switching of the first and second legs of synchronous rectifier 216 at various phase shifts between the switching of the first and second legs and the zero-crossing of receiver current I_{RX}, according to an embodiment of the present invention.

FIG. 9A illustrates the switching of the first and second legs with a phase shift of 0° with respect to the zero-crossing of current I_{RX}. As shown in FIG. 9A, the switching of the first and second legs occurs at the zero-crossing of current I_{RX} (delay t_{d}=0). As can be seen from FIG. 9A, the rectified voltage V_{RX_DC} produced by the switching of the first and second legs is about 23 V (similar to the peak voltage of voltages V_{RXN} and V_{RXP} illustrated in FIG. 9A).

FIG. 9B illustrates the switching of the first and second legs with a phase shift of 21° with respect to the zero-crossing of current I_{RX}. As shown in FIG. 9B, the switching of the first and second legs occurs after the zero-crossing of current I_{RX} (positive delay t_{d}). As can be seen from FIG. 9B, the rectified voltage V_{RX_DC} produced by the switching of the first and second legs is about 26 V, which is higher than the 23 V produced with no delay added (as shown in FIG. 9A).

FIG. 9C illustrates the switching of the first and second legs with a phase shift of −21.6° with respect to the zero-crossing of current I_{RX}. As shown in FIG. 9C, the switching of the first and second legs occurs before the zero-crossing of current I_{RX} (negative delay t_{d}). As can be seen from FIG. 9C, the rectified voltage V_{RX_DC} produced by the switching of the first and second legs is about 18 V, which is lower than the 23 V produced with no delay added (as shown in FIG. 9A).

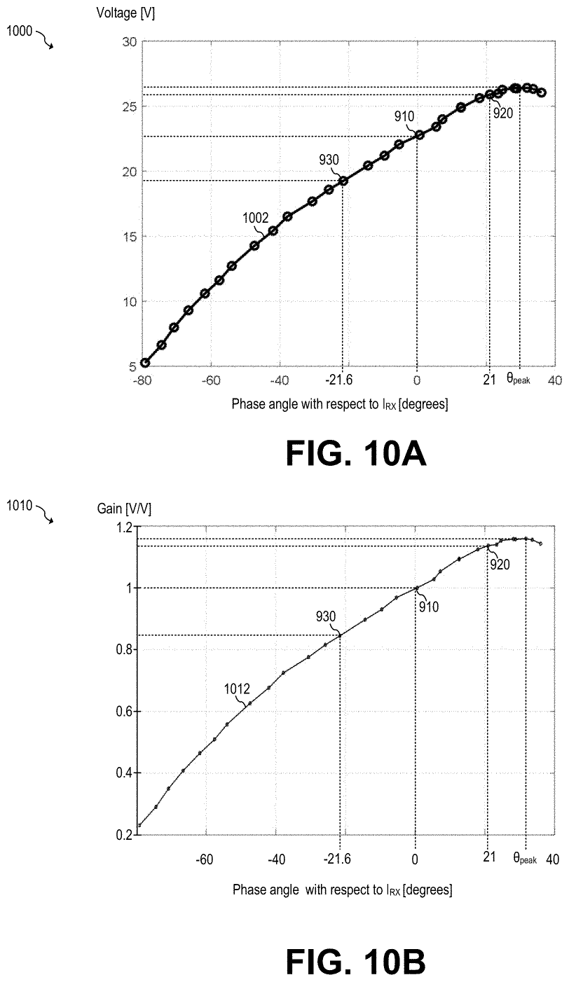

FIG. 10A shows plot 1000 of voltage V_{RX_DC} versus phase angle between the switching of the first and second legs and receiver current I_{RX} (as shown by curve 1002), according to an embodiment of the present invention. Phase angles higher than 0° correspond to a positive delay t_{d}, phase angles lower than 0° correspond to a negative delay t_{d}, and a phase angle of 0° correspond to a delay t_{d} of 0. Operating points 910, 920, and 930 are illustrated in greater detail in FIGS. 9A, 9B, and 9C, respectively.

FIG. 10B shows plot 1010 of gain versus phase angle between the switching of the first and second legs and receiver current I_{RX}, according to an embodiment of the present invention. Curve 1012 illustrates the change in voltage V_{RX_DC} obtained by modulating the phase angle between the switching of the first and second legs and receiver current I_{RX}. For example, a phase angle of 0° corresponds to no delay t_{d} applied (operating point 910), and thus has a gain of 1. A phase angle of 21° corresponds to a positive delay t_{d} applied (operating point 920), and has a gain of about 1.13, resulting from dividing voltage V_{RX_DC} from operating point 920 (illustrated in FIG. 9B) over voltage V_{RX_DC} from operating point 910 (illustrated in FIG. 9A). A phase angle of −21.6° corresponds to a negative delay t_{d} applied (operating point 930), and has a gain of about 0.78, resulting from dividing voltage V_{RX_DC} from operating point 930 (illustrated in FIG. 9C) over voltage V_{RX_DC} from operating point 910 (illustrated in FIG. 9A).

As shown in FIG. 10B, in some embodiments, applying positive delays t_{d} causes the gain (with respect to a phase angle of 0) to increase above 1 (thus amplifying voltage V_{RX_DC}), reaching a peak phase angle θₚₑₐₖ. As also shown in FIG. 10B, in some embodiments, applying negative delays t_{d} causes the gain (with respect to a phase angle of 0) to decrease below 1 (thus attenuating voltage V_{RX_DC}).

As illustrated by FIGS. 10A and 10B, changing the switching time of the first and second legs by delaying or advancing the switching of the first and second legs with respect to the zero-crossing of receiver current I_{RX} by a phase angle (e.g., corresponding to a time t_{d}) allows for regulating voltage V_{RX_DC} to a target voltage. In some embodiments, the target voltage may be 20 V. Other target voltages, such as higher than 20 V (e.g., 22 V, 25 V, 30 V, or higher) or lower than 20 V (e.g., 18 V, 12 V, or lower) are also possible. In some embodiments, the target voltage may be programmable.

Some embodiments may regulate voltage V_{RX_DC} to a target voltage by applying positive and negative delays (tₚ) between the first and second legs of synchronous rectifier 216.

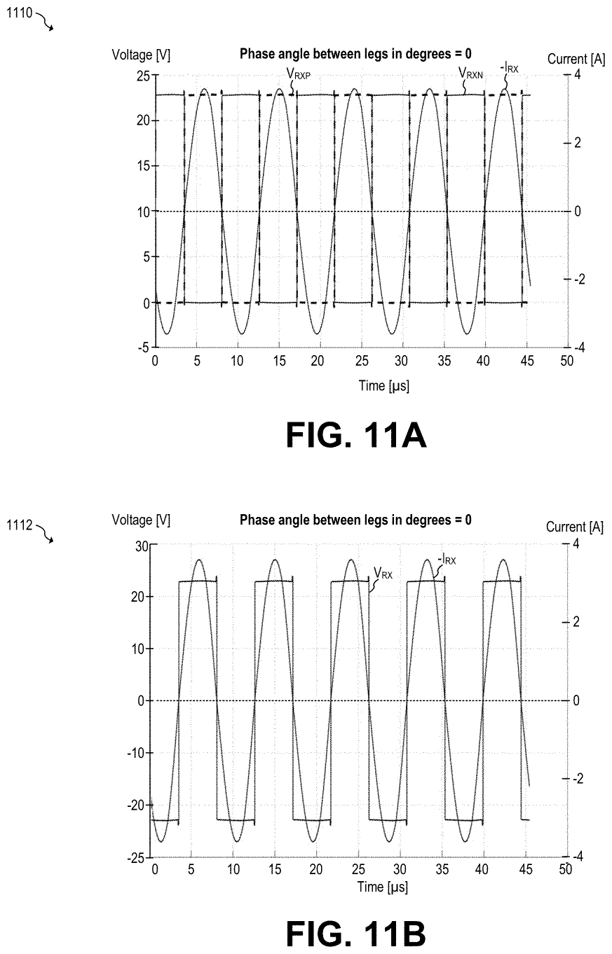

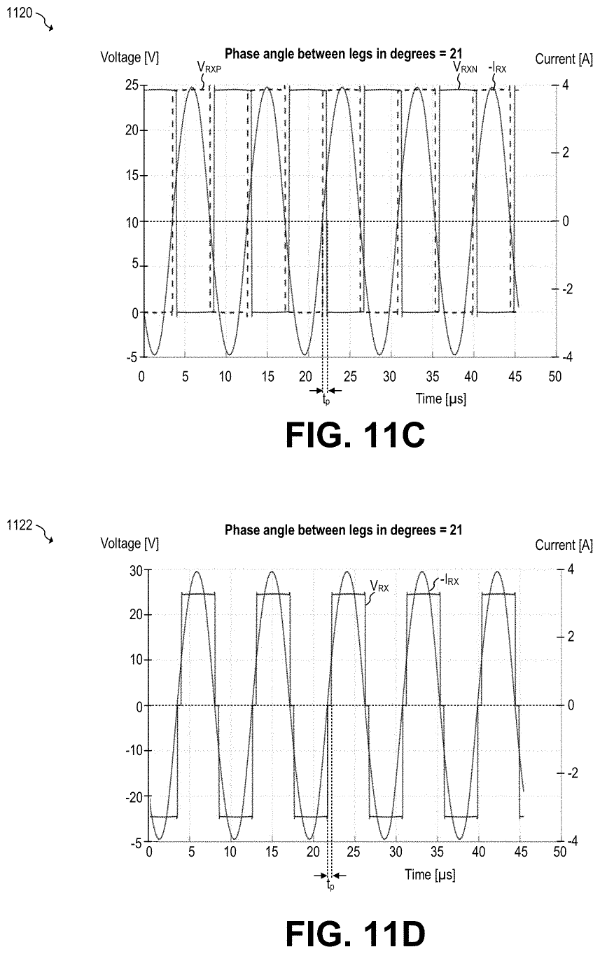

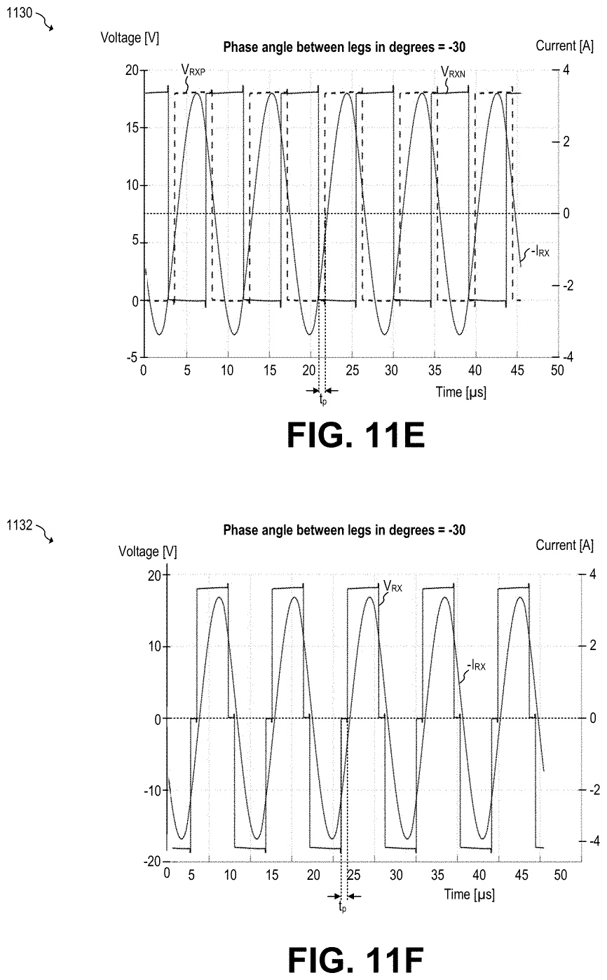

FIGS. 11A-11F illustrate the switching of the first and second legs of synchronous rectifier 216 at various phase shifts between the first and second legs, according to an embodiment of the present invention.

FIGS. 11A and 11B illustrate the switching of the first and second legs with a phase shift between the first and second legs of 0°, FIG. 11A illustrates voltages V_{RXP}, and V_{RXN}, and −I_{RX}. FIG. 11B shows voltage V_{RX} (V_{RXP}−V_{RXN}) and current −I_{RX}.

As shown in FIGS. 11A and 11B, the switching of the first and second legs occurs at the zero-crossing of current I_{RX} (delay t_{d}=0) and with no phase difference between the first and second legs (delay tₚ=0). Thus, thus, there is no overlap between the first and second legs.

As can be seen from FIGS. 11A and 11B, the rectified voltage V_{RX_DC} produced by the switching of the first and second legs is about 23 V (similar to the peak voltage of voltages V_{RXN} and V_{RXP} illustrated in FIG. 11A, and the V_{RX} peak voltage illustrated in FIG. 11B).

FIGS. 11C and 11D illustrate the switching of the first and second legs with a phase shift between the first and second legs of 21° (positive delay tₚ). FIG. 11C illustrates voltages V_{RXP}, and V_{RXN}, and −I_{RX}. FIG. 11D shows voltage V_{RX} (V_{RXP}−V_{RXN}) and current −I_{RX}.

As shown in FIG. 11C, the switching of the first and second legs overlap for a period tₚ, with the second leg transitioning after the first leg. In the example illustrated in FIGS. 11C and 11D, the first leg (as illustrated by curve V_{RXP}) transitions at the zero-crossing of current I_{RX}, and the second leg (as illustrated by curve V_{RXN} ) transitions tₚ time after the transition of the first leg. In some embodiments, the transition of the first leg may not coincide with the zero-crossing of current I_{RX}.

As can be seen from FIGS. 11C and 11D, the rectified voltage V_{RX_DC} produced by the switching of the first and second legs is about 26 V, which is higher than the 23 V produced with no delay added (as shown in FIGS. 11A and 11B).

FIGS. 11E and 11F illustrate the switching of the first and second legs with a phase shift between the first and second legs of −30° (negative delay tₚ). FIG. 11E illustrates voltages V_{RXP}, and V_{RXN}, and −I_{RX}. FIG. 11F shows voltage V_{RX} (V_{RXP}−V_{RXN} ) and current −I_{RX}.

As shown in FIG. 11E, the switching of the first and second legs overlap for a period tₚ, with the first leg transitioning after the second leg. In the example illustrated in FIGS. 11C and 11D, the first leg (as illustrated by curve V_{RXP}) transitions before the zero-crossing of current I_{RX}, and the second leg (as illustrated by curve V_{RXN}) transitions tₚ time before the transition of the first leg. In some embodiments, the first leg may transition at the zero crossing of current I_{RX}.

As can be seen from FIGS. 11C and 11D, the rectified voltage V_{RX_DC} produced by the switching of the first and second legs is about 18 V, which is lower than the 23 V produced with no delay added (as shown in FIGS. 11A and 11B).

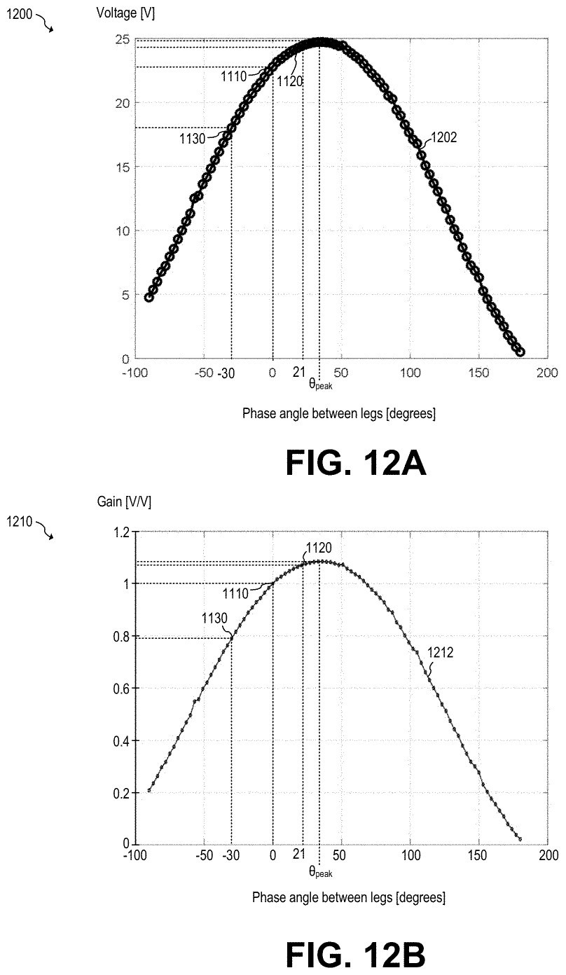

FIG. 12A shows plot 1200 of voltage V_{RX_DC} versus phase angle between the switching of the first and second legs (as shown by curve 1202), according to an embodiment of the present invention. Phase angles higher than 0° correspond to a positive delay tₚ, phase angles lower than 0° correspond to a negative delay tₚ, and a phase angle of 0° correspond to a delay tₚ of 0. Operating points 1110, 1120, and 1130 are illustrated in greater detail in FIGS. 11A, 11C, and 11E, respectively.

FIG. 12B shows plot 1210 of gain versus phase angle between the switching of the first and second legs, according to an embodiment of the present invention. Curve 1212 illustrates the change in voltage V_{RX_DC} obtained by modulating the phase angle between the switching of the first and second legs. For example, a phase angle of 0° corresponds to no delay tₚ applied (operating point 1110), and thus has a gain of 1. A phase angle of 21° corresponds to a positive delay tₚ applied (operating point 1120), and has a gain of about 1.13, resulting from dividing voltage V_{RX_DC} from operating point 1120 (illustrated in FIG. 11C) over voltage V_{RX_DC} from operating point 1110 (illustrated in FIG. 11A). A phase angle of −30° corresponds to a negative delay tₚ applied (operating point 1130), and has a gain of about 0.78, resulting from dividing voltage V_{RX_DC} from operating point 1130 (illustrated in FIG. 11E) over voltage V_{RX_DC} from operating point 1110 (illustrated in FIG. 11A).

As shown in FIG. 12B, in some embodiments, applying positive delays tₚ causes the gain (with respect to a phase angle of 0) to increase above 1 (thus amplifying voltage V_{RX_DC}), reaching a peak phase angle θₚₑₐₖ. As also shown in FIG. 12B, in some embodiments, applying negative delays tₚ causes the gain (with respect to a phase angle of 0) to decrease below 1 (thus attenuating of voltage V_{RX_DC}).

As illustrated by FIGS. 12A and 12B, changing the switching time of the first and second legs by delaying or advancing the switching of the first and second legs with respect to each other by a phase angle (e.g., corresponding to a time tₚ) allows for regulating voltage V_{RX_DC} to a target voltage. In some embodiments, the target voltage may be 20 V. Other target voltages, such as higher than 20 V (e.g., 22 V, 25 V, 30 V, or higher) or lower than 20 V (e.g., 18 V, 12 V, or lower) are also possible. In some embodiments, the target voltage may be programmable.

In some embodiments, regulating voltage V_{RX_DC} to a target voltage using synchronous rectifier 216 advantageously allows for avoiding voltage spikes during a load transient event, thus advantageously protecting the circuit(s) (e.g., converter 214 and/or LDO 226) coupled to the output of synchronous rectifier 216 and/or protecting transistors 217, 218, 219, and/or 220 for damage or malfunctions caused by the overvoltage event. For example, when a load transient occurs, such as when the current consumed by load 228 suddenly decreases), voltage V_{RX_DC} may increase as a result. In some embodiments, changing the phase angle between the switching of the first and second legs with respect to current I_{RX} or with respect to each other, to apply a gain lower than 1 (e.g., by applying a negative delay t_{d} or negative delay tₚ) may cause voltage V_{RX_DC} to remain at the target voltage (e.g., 20 V). In some embodiments, the response time to a load transient event is less than 2 ms , such as within 10 switching cycles or 100 μs.

In some embodiments, synchronous rectifier 216 continuously regulates voltage

V_{RX_DC} to a target voltage. By continuously regulating voltage V_{RX_DC} to a target voltage, some embodiments advantageous achieve lower voltage spikes as a result of a transient event and/or voltage spikes of shorter duration. In some embodiments, when the synchronous rectifier operates at a phase angle that is higher than a positive threshold or lower than a negative threshold, wireless power receiver 204 transmit a request to wireless power transmitter 202 to change the transmitted power to a level so that the phase angle can return to a level closer to 0 (e.g., between the negative threshold and the positive threshold). For example, when the phase angle is lower than −21.6 degrees, decreasing the transmitted power may cause the phase angle to increase towards 0 degrees, which may advantageously increase efficiency.

In some embodiments, regulation of voltage V_{RX_DC} to a target voltage is activated upon detection of a load transient event. For example, in some embodiments, a comparator is used to detect a load transient event when voltage V_{RX_DC} increases, e.g., by more than 5% (e.g., higher than 21 V for a 20 V target). As a result of the detection (e.g., when the output of the comparator is asserted), synchronous rectifier 216 modulates the switching time of the first and second legs with respect to current I_{RX} to cause voltage V_{RX_DC} to return and remain at the target voltage (e.g., 20 V). In some embodiments, the time between load transient detection until voltage V_{RX_DC} is regulated at the target voltage is less than 2 ms. In some embodiments, wireless power receiver 204 transmit a request to wireless power transmitter 202 to lower the transmitted power. Once wireless power transmitter 202 lowers the power to a new level, synchronous rectifier 216 stops regulating voltage V_{RX_DC} and returns to synchronous rectification with a phase angle of 0.

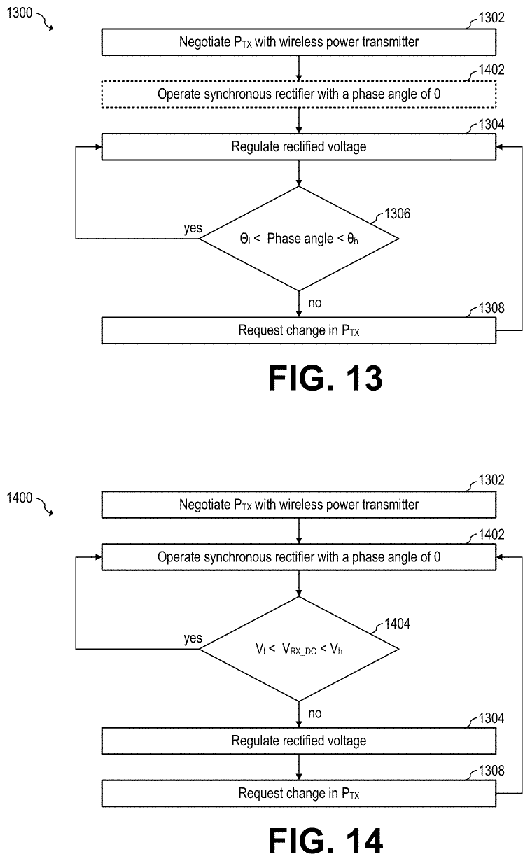

FIG. 13 shows a flow chart of embodiment method 1300 for regulating rectified voltage V_{RX_DC}, according to an embodiment of the present invention.

During step 1302, the power level P_{TX} transmitted by a wireless power transmitter (e.g., 102, 202) is negotiated. For example, in some embodiments the power negotiation is performed between the wireless power transmitter and a wireless power receiver (e.g., 204) using in-band communication in accordance with the Qi standard (e.g., version 1.2.3).

In some embodiments, the in-band communication used for power negotiation is performed using a synchronous rectifier (e.g., 216) of the wireless power receiver (e.g., using methods 600, 700, or 800). In some embodiments, the in-band communication used for power negotiation is performed using a capacitor bank (e.g., 120) in a conventional manner.

In some embodiments, after the power negotiation ends, the synchronous rectifier produces, for the loading present during the power negotiation (e.g., load 228) the rectified voltage V_{RX_DC} at the target voltage (e.g., 20 V) when switching the first and second legs at the zero-crossing of the receiver current I_{RX} (delay t_{d}=0, and delay tₚ=0).

As the load changes, the synchronous rectifier changes during step 1304 the phase angle between the switching of the first and second legs with respect to current I_{RX} or the phase angle between the switching of the first and second leg to adjust the gain (e.g., increase or decrease) to maintain voltage V_{RX_DC} at the target voltage. In some embodiments, a controller (e.g., controller 230) controls the switching timing of the synchronous rectifier so as to adjust the phase angle.

When the phase angle is within a predefined phase angle range (e.g., between θₗ and θₕ), the synchronous rectifier continues to adjust the phase angle to regulate voltage V_{RX_DC}, as illustrated by step 1306. If it is determined during step 1306 that the phase angle is outside the predefined phase angle range, then the wireless power receiver requests the wireless power transmitter during step 1308 to change the transmitted power P_{TX} (e.g., using in-band communication). In some embodiments, after the request for changing the transmitter power P_{TX} is processed and acknowledged by the wireless power transmitter, the synchronous rectifier produces, for the loading present at the time the request is made, the rectified voltage V_{RX_DC} at the target voltage (e.g., 20 V) when switching the first and second legs at the zero-crossing of the receiver current I_{RX} (delay t_{d}=0, and delay tₚ=0).

In some embodiments, this between θₗ and −5° and −30° (e.g., such as −10°) and θₕ is between 5° and 30° (e.g., such as 5°). Other values for θ₁ and θₕ may also be used.

FIG. 14 shows a flow chart of embodiment method 1400 for regulating rectified voltage V_{RX_DC}, according to an embodiment of the present invention. Method 1400 includes steps 1302, 1402, 1404, 1304, and 1308. Steps 1302, 1304, and 1308 may be performed, e.g., as described with respect to method 1300.

During step 1402, the synchronous rectifier operates by switching the first and second legs at the zero-crossing of the receiver current I_{RX} (delay t_{d}=0, and delay tₚ=0). In some embodiments, when the loading of the synchronous rectifier during step 1402 is the same as the loading of the synchronous rectifier during step 1302, the synchronous rectifier produces the rectified voltage V_{RX_DC} at the target voltage (e.g., 20 V).

As the load changes, the rectified voltage V_{RX_DC} varies. When the rectified voltage V_{RX_DC} is within a predefined voltage range (e.g., between Vₗ and Vₕ), the synchronous rectifier continues switch the first and second legs at the zero-crossing of the receiver current I_{RX} (delay t_{d}=0, and delay tₚ=0), as illustrated by step 1404. In some embodiments, the rectified voltage V_{RX_DC} is monitored/measured/determined by using a circuit (e.g., an ADC, or comparator) coupled to the output of the synchronous rectified (e.g., directly, via a voltage divider, or in other ways) in a known manner.

If it is determined during step 1404 that the rectified voltage is outside the predefined voltage range, then the synchronous rectifier regulates the rectified voltage V_{RX_DC} to the target voltage during step 1304 by adjusting the phase angle, and requests a change in transmitted power P_{TX} during step 1308.

In some embodiments, after the request for changing the transmitter power P_{TX} is processed and acknowledged by the wireless power transmitter, the synchronous rectifier produces, for the loading present at the time the request is made, the rectified voltage V_{RX_DC} at the target voltage (e.g., 20 V) when switching the first and second legs at the zero-crossing of the receiver current I_{RX} (delay t_{d}=0, and delay tₚ=0), and step 1402 is performed.

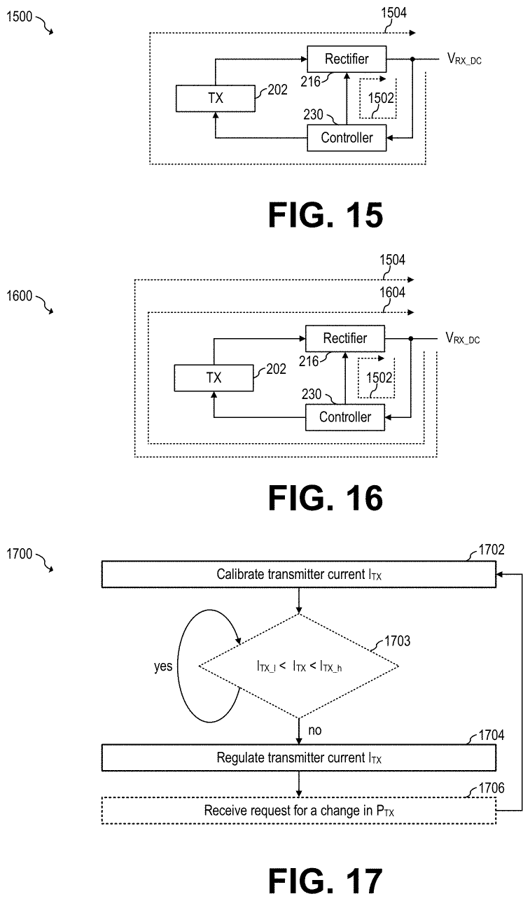

As illustrated in FIGS. 13 and 14, some embodiments, have 2 feedback loops for regulating the rectified voltage V_{RX_DC} . A first feedback loop includes regulating the rectified voltage V_{RX_DC} by adjusting the phase angle between the switching of the first and second legs and the current I_{RX} or the phase angle between the first and second legs. A second feedback loop includes requesting, by the wireless power receiver to the wireless power transmitter, a change in the transmitted power level P_{TX}, e.g., in accordance with the Qi specification (e.g., version 1.2.3). FIG. 15 shows block diagram 1500 illustrating the first feedback loop 1502 and the second feedback loop 1504 for regulating the rectified voltage V_{RX_DC}, according to an embodiment of the present invention.

As shown in FIG. 15, the first feedback loop 1502 includes monitoring the rectified voltage V_{RX_DC} by controller 230, and adjusting the phase angle between the switching of the first and second legs of synchronous rectifier 216 and current I_{RX} or the phase angle between the first and second legs to regulated voltage V_{RX_DC} to a target voltage.

As shown in FIG. 15, the second feedback loop 1504 includes monitoring the rectified voltage V_{RX_DC} by controller 230, and requesting wireless power transmitter 202 a change in the level of the transmitter wireless power (e.g., via in-band communication) to cause the rectified voltage V_{RX_DC} to have the target voltage.

In some embodiments, the first feedback loop is more than an order of magnitude faster (or even more than two orders of magnitude faster) than the second loop. Thus, some embodiments, are advantageously capable of reacting in a fast manner (e.g., within 2 ms ) to a load transient, thus advantageously reducing the ripple, overshoot, and/or undershoot of rectified voltage V_{RX_DC} .

By reacting in a fast manner to a load transient, some embodiments advantageously protect circuits coupled to the output of the synchronous rectified from overvoltage conditions without using an additional overvoltage protection circuit. Additional advantages of some embodiments include maintaining an input voltage within the specification to a power converter (e.g., 214, 226) so as to keep a steady voltage delivered to the load (e.g., 228) despite a temporary or permanent change in the current consumed by the load.

In some embodiments, such as some embodiments that implement LDO 226, reacting in a fast manner to a load transient advantageously results in less power (and less heat) being dissipated by the LDO as a result of an increase the in voltage V_{RX_DC} .

In some embodiments, operating the second loop advantageously allows the synchronous rectifier to operate with a phase angle at or near 0 while still generating the rectified voltage V_{RX_DC} at the target voltage. Thus, some embodiments advantageously generate the rectified voltage V_{RX_DC} at the target voltage while operating at or near maximum wireless power transmission efficiency.

Advantages of some embodiments include regulating the rectified voltage V_{RX_DC} and reacting to load transients in a fast manner (e.g., in less than 2 ms ) by operating the synchronous rectified with a phase angle (with respect to current I_{RX} or between the first and second legs) different than 0 for shorts period of times (e.g., less than 1 second) while operating at or near maximum wireless power transfer efficiency by switching the first and second legs at the zero-crossing of current I_{RX} for most of the time.

In some embodiments, the wireless power transmitter 202 may detect a change in impedance, as seen from the wireless power transmitter 202, resulting from the adjustment of the phase angle (e.g., during step 1304), and, in response, may adjust the level of wireless power transmitted P_{TX}. For example, when load current I_{LOAD} increases, the phase angle is increased during step 304 (e.g., by increasing the positive delay t_{d} or tₚ) to regulate the rectified voltage V_{RX_DC} to the target voltage. The increase in the phase angle of the switching of the first and second legs causes an impedance change that causes an increase in the transmitter current I_{TX} flowing through the LC tank 106. Similarly, when load current I_{LOAD} decreases, the phase angle is decreased during step 304 (e.g., by increasing the negative delay t_{d} or tₚ) to regulate the rectified voltage V_{RX_DC} to the target voltage. The decrease in the phase angle of the switching of the first and second legs causes an impedance change that causes a decrease in the transmitter current I_{TX}. Thus, in some embodiments, the wireless power transmitter (e.g., 202) regulates the transmitter current I_{TX} to a target (e.g., peak, or RMS) transmitter current to adjust the level of transmitted power P_{TX} (e.g., before receiving a request to adjust the level of transmitted power P_{TX} via, e.g., in-band communication).

FIG. 16 shows block diagram 1600 illustrating feedback loop 1604 for regulating the level of transmitted power P_{TX}, according to an embodiment of the present invention. As shown in FIG. 16, feedback loop 1604 may operate in conjunction with feedback loops 1502 and 1504.

In some embodiments, adjusting the phase angle of the synchronous rectifier 216 during step 1304 may cause a change in (e.g., peak or RMS value of) transmitter current I_{TX}. In some embodiments, the wireless power transmitter may detect the change in transmitter current I_{TX} and may regulate the transmitter current I_{TX} so that it remains in the same level. For example, FIG. 17 shows a flow chart of embodiment method 1700 for regulating transmitter current I_{TX}, according to an embodiment of the present invention.

During step 1702, a wireless power transmitter (e.g., 202) measures and stores (e.g., in a memory of the wireless power transmitter) a level (e.g., peak or RMS) of the transmitter current I_{TX}. The level of the transmitter current ITX determined during step 1702 may be referred to as a transmitter calibration current, or as a transmitter target current.

Step 1702 may be performed when the synchronous rectifier (e.g., 216) of the wireless power receiver (e.g., 204) is switching at the zero-crossing of the receiver current I_{RX} (e.g., when t_{d}=tₚ=0). For example, step 1702 may be performed during 1402. In some embodiments, method 1300 may include step 1402 between steps 1302 and 1304, e.g., for a limited period of time (e.g., less than 1 second) during which step 1702 is performed.

The wireless power transmitter may measure the transmitter current I_{TX} in any way known in the art, such as based on a voltage across transistors 206, 207, 208, and/or 209, based on a voltage across a sense resistor through with current I_{TX} (or a current based on current I_{TX} flows), or in any other way known in the art.

During step 1704, the wireless power transmitter regulates the current I_{TX} so that it is at the level of the transmitter target current.

In some embodiments, a request for changing the level of transmitted power P_{TX} is received during step 1706. Such request may be sent by the wireless power receiver (e.g., during step 1308) and may be performed, e.g., in accordance with the Qi standard (e.g., version 1.2.3).

In some embodiments, when a request for changing the level of transmitted power P_{TX} is received during step 1706, the wireless power transmitter may perform step 1702 once the new level of transmitted power is settled.

As shown in FIG. 17, step 1703, in some embodiments, current I_{TX} is only regulated once the transmitter current I_{TX} is outside a predetermined range (e.g., lower than current I_{TX_l} or higher than current I_{TX_h} ). In some embodiments, currents I_{TX_h}, and I_{TX_l} may correspond to +/−5% of the target transmitter current, respectively. Other values may also be used.

In some embodiments, changes to delay time t_{d} or tₚ (e.g., for voltage regulation purposes) are made at a frequency selected so as to not interfere with in-band communication (where the in-band frequency range may be, e.g., between 1 kHz and 2 kHz). For example, in some embodiments, changes to delay time t_{d} or tₚ for voltage regulation purposes may be performed at a frequency lower than 1 kHz, such as 100 Hz or lower or at a frequency of 10 kHz, or higher.

In some embodiments, wireless power receiver 204 performs voltage regulation of V_{RX_DC} by modulating the delay time t_{d} and/or tₚ simultaneously with in-band communication. For example, in some embodiments, the sudden and gradual increase in delay times (e.g., as performed in steps 704, 706, 804, and 806) are performed with respect to the fixed delay times (e.g., tₚ and/or t_{d}) used for regulating the rectified voltage V_{RX_DC} (e.g., during step 1304).

In some embodiments, the switching times of the first and second legs of synchronous rectifier 216 are based on the receiver current I_{RX}. For example, in some embodiments, synchronous rectifier 216 (or associated controller 230) determines when to switch transistors 217, 218, 219, and 220 (either before, after or at the zero-crossing of current I_{RX}) based on detecting the zero-crossing current I_{RX} . For example, in some embodiments, the next transistor that is to be turned off, e.g., based on the synchronous rectification sequence (such as shown by curve 304 of FIG. 3B) turns off based on the time in which current I_{RX} becomes 0 A (e.g., by detecting when current I_{RX} becomes 0 A, or by detecting when the magnitude of current I_{RX} becomes lower than a predetermined threshold). In some embodiments, the next transistor that is to be turned on, e.g., based on the synchronous rectification sequence, turns on based on detecting forward diode conduction across such transistor. Thus, some embodiments, determine the switching directly based on measurements performed every switching cycle.

In some embodiments, the switching of the first and second legs are both determined based on the zero-crossing of current IRX, such as when applying positive delays t_{d} or negative delays t_{d}. In some embodiments, the switching of one leg (e.g., the first leg) of the synchronous rectifier 216 is determined based on the zero-crossing of current I_{RX} such that it switches, e.g., at the zero crossing, while the switching of the other leg (e.g., the second leg) is determined with respect to the switching of the first leg, such as when applying positive delays tₚ or negative delays tₚ.

In an embodiment of the present invention, a phase-locked loop (PLL) is used to control the switching of a synchronous rectifier coupled to the RX LC tank, or as reference signal in which to base the timing of the switching of the first and second legs of the synchronous rectifier. An oscillating signal based on zero-crossing detection and forward diode conduction detection of a transistor of the synchronous rectifier 216 is used as a reference signal for the PLL. In some embodiments, using a PLL for controlling the synchronous rectifier advantageously improves the accuracy of the switching times of the synchronous rectifier, which may be corrupted based on noisy measurements for zero-crossing and forward diode conduction detections.

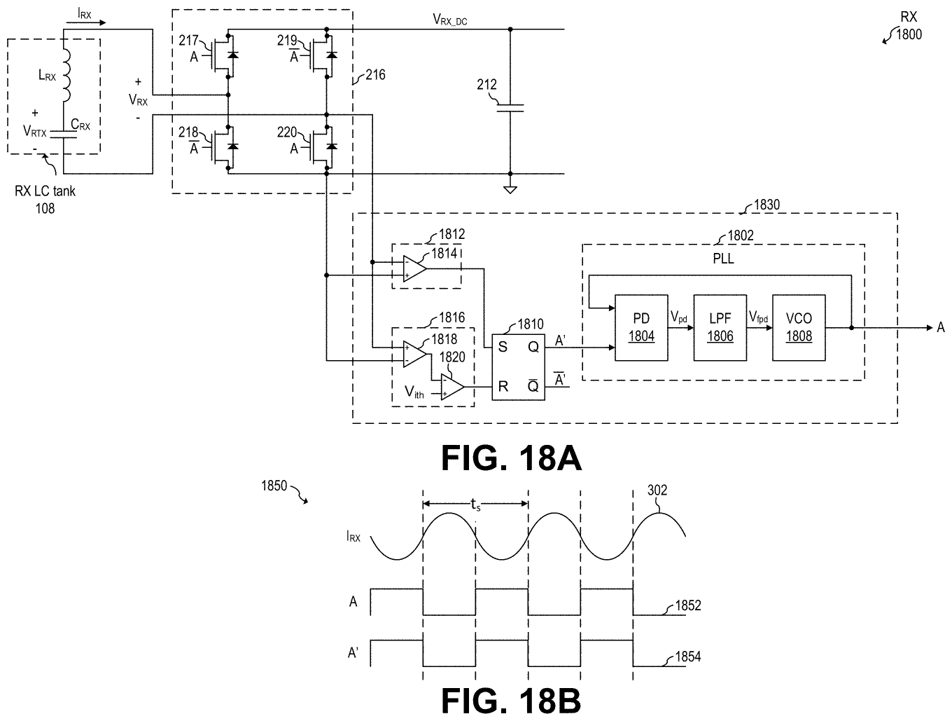

FIGS. 18A and 18B show wireless power receiver 1800, and associated waveforms 1850, respectively, according to an embodiment of the present invention. Wireless power receiver 1800 includes RX LC tank 108, synchronous rectifier 216, filtering capacitor 212 and controller 1830. Controller 1830 includes zero-crossing detector 1816, forward diode conduction detector 1812, flip-flop 1810 and PLL 1802. PLL 1802 includes phase comparator 1804, low-pass filter (LPF) 1806, and voltage controlled oscillator (VCO) 1808. As shown, FIG. 18A illustrates the body diodes of transistors 217, 218, 219, and 220. Wireless power receiver 204 may be implemented as wireless power receiver 1800. In some embodiments, controller 1830 may be implemented as part of controller 230.

Curves 1852 and 1854 illustrate signals A and A′, respectively, of an embodiment in steady state.

During normal operation, zero-crossing detector 1816 detects the zero-crossings of current I_{RX}, and resets flip-flop 1810 when current I_{RX} is at the zero-crossing (e.g., when current flowing through the current path of transistor 220 is below a predetermined threshold Vᵢₜₕ). Forward diode conduction detector 1812 detects when transistor 220 is in forward diode conduction mode and sets flip-flop 1810 when transistor 220 is in forward diode conduction mode (e.g., when the drain voltage of transistor 220 is lower than the source voltage of transistor 220).

In some embodiments, signal A′ produced by flip-flop 1810 is equal to curve 304 (e.g., in steady state).

Signal A′ is used as a reference signal for PLL 1802, which then produces signal A for driving synchronous rectifier 216, as shown by curve 1852. For example, in some embodiments, phase comparator 1804 produces voltage V_{pd}, which is proportional to the phase different between signal A and signal A′. Voltage V_{pd} is then low-pass filtered to produce filtered voltage V_{fpd}, which controls VCO 1808. PLL 1802 operates to minimize the frequency and phase error between A and A′, e.g., in a known manner. Thus, in some embodiments, in steady state, the output A of PLL 1802 and signal A′ may be equal.

In some embodiments, the output of PLL 1802 (e.g., signal A at the output of PLL 1802) is used to drive synchronous rectifier 216. In some embodiments, the output of PLL 1802 is used as a reference signal, and controller 1830 controls the switching of transistors 217, 218, 219, and 220, e.g., to switch with delay t_{d} with respect to the output of PLL 1802. In some embodiments, the output of PLL 1802 is used as a reference signal, and controller 1830 controls the switching of one leg (e.g., transistors 217, 218) based on the output of PLL 1802, and controls the switching of the other leg (e.g., transistors 219, 220) to switch with delay tₚ with respect to the switching of the one leg and/or with respect to the output of PLL 1802.

In some embodiments, using PLL 1802 advantageously allows for proper driving of synchronous rectifier 216 when failing to detect or improperly detecting a zero-crossing and/or a forward diode conduction events (e.g., since low-pass filter 506 may filter such corrupted detection, leaving signal A unaffected). Additional advantages of some embodiments include driving synchronous rectifier 216 with low jitter and increased wireless power transfer efficiency.

Zero-crossing detector 1816 may be implemented, e.g., using amplifier 1818 followed by comparator 1820 to compare the voltage drop across transistor 220 (e.g., when transistor 220 is on) with a reference value, (e.g., since such voltage drop is proportional to the current flowing through transistor 220 times the rdson resistance of transistor 220). Other implementations for sensing zero-crossing events, such as using an ADC, are also possible.

Forward diode conduction detector 1812 may be implemented, e.g., using comparator 1814 to compare the drain and source voltages of transistor 220 (when transistor 220 is off) to produce an indication when the drain voltage is lower than the source voltage. Other implementations are also possible.

Although FIG. 18A shows detectors 1812 and 1816 coupled to transistor 220, a person skilled in the art would understand how to modify the circuit so that it is based on a different transistor of synchronous rectifier 216, such as transistors 217, 218, or 219.

In some embodiments, PLL 1802 is implemented as shown in FIG. 18A. Other implementations, such as using a proportional-integral (PI) controller, are also possible.

In some embodiments, controller 1830 may implement PLL 1802, e.g., digitally. For example, in some embodiments, circuits 1812, 816 and 1810 may be replaced by an ADC followed by digital circuits to implement zero-crossing detection and forward diode conduction detection. For example, in some embodiments, controller 1830 may be implemented, e.g., as a general purpose or custom microcontroller including combinatorial logic coupled to a memory.

In some embodiments, controller 1830 may implement, e.g., additionally, the functionality of controller 1830, such as for performing in-band communication, for controlling converter 214, and/or for performing V_{RX_DC} voltage regulation. For example, in some embodiments, the output of PLL 1802 may be used as a reference by controller 1830 for controlling transistors 217, 218, 219, and 220, and controller 1830 may modify the switching of transistors 217, 218, 219, and 220 (e.g., instead of following the output of PLL 1802 exactly) to introduce delays t_{d}, delay tₚ, and/or period tₕ.

In some embodiments, wireless power transmitter 202 may change the operating frequency of TX LC tank 106, thus affecting the operating frequency of RX LC tank 108. If a PLL, such as PLL 1802, is used to drive synchronous rectifier 216, the signal A at the output of PLL 1802 may be out of synch with current I_{RX}. As a result of signal A being out of synch with current I_{RX}, the detection window for performing zero-crossing detection and forward diode conduction detection may occur far from the zero-crossing of current I_{RX}. Thus, signal A′ may be corrupted (e.g., stuck at a particular state or switching at a frequency different than the frequency of current I_{RX}).

In some embodiments, when the PLL (e.g., 1802) loses synchronization with the received reference signal (e.g., A′), the duty cycle of the synchronous rectifier (e.g., 216) is (e.g., incrementally) reduced, while being driven based on the output of the PLL, to (e.g., incrementally) increase the dead-time for detecting the zero-crossings and forward diode conduction of a transistor (e.g., 220) of the synchronous rectifier, to, e.g., facilitate the locking of the PLL to the new frequency and phase.

In an embodiment, transistor 220 is off during a dead-time that spans from before transistor 220 is expected to switch until after transistor 220 is expected to switch. The dead-time, thus, allows for proper measurement of forward diode conduction of transistor 220 (since, detector 1812 is capable of detecting forward diode conduction when transistor 220 is off).

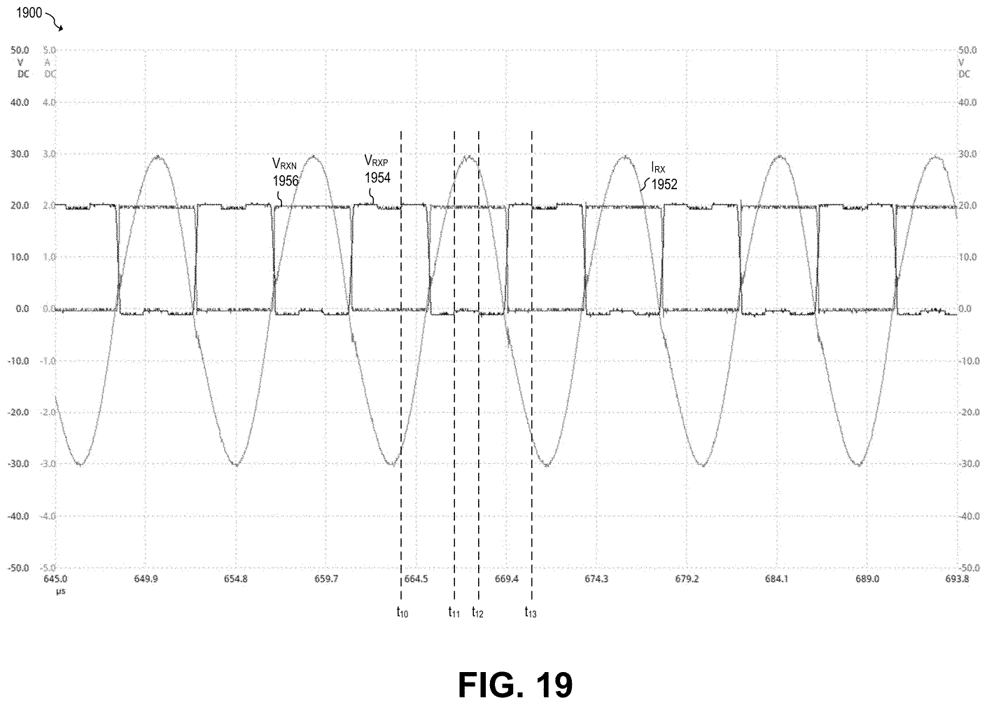

For example, in some embodiments, the dead-time during steady state (where the output of PLL 1802 and signal A′ are locked) may be, e.g., less than 20% of the switching period, such as less than 10%, or lower. As a non-limiting example, FIG. 2B shows an embodiment having a dead-time of about 1.5 μs (from t₀ to t₂, and from t₃ to t₅). FIG. 19 shows waveforms 1900 illustrating an example of a longer dead-time, according to an embodiment of the present invention.

As illustrated by FIGS. 2B and 19, in some embodiments, the dead-time may be increased (the duty cycle of the synchronous rectifier may be reduced) when PLL 1802 loses synchronization to facilitate and speed-up resynchronization. Once the output of PLL 1802 is resynchronized with signal A′, the dead-time may be reduced, either gradually or abruptly, to a normal operation dead-time, such as illustrated in FIG. 2B.

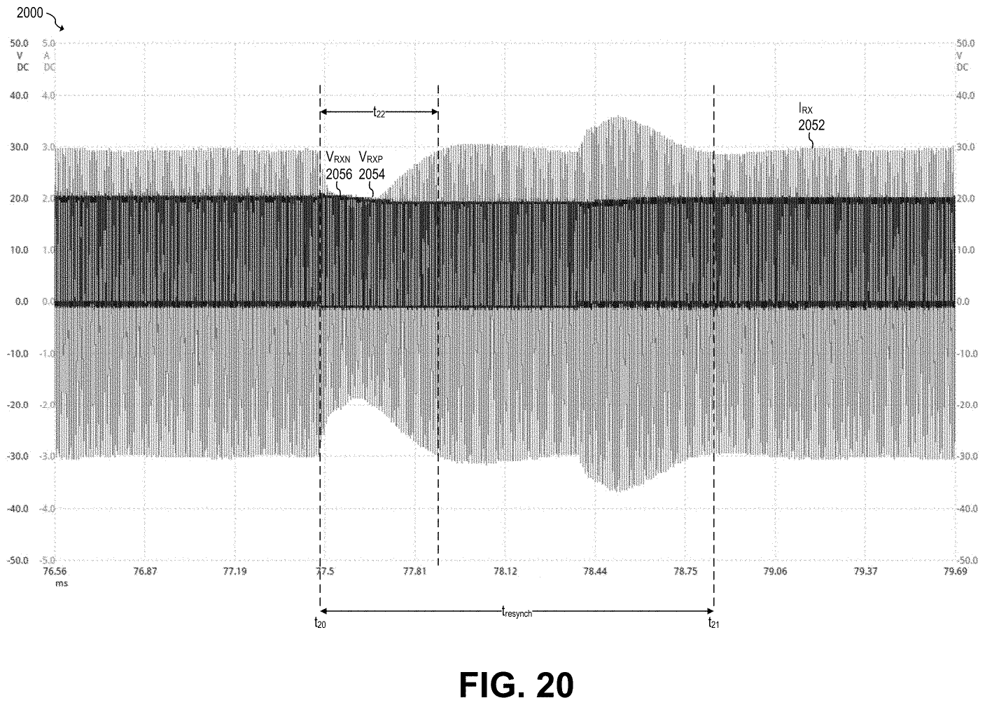

FIG. 20 shows waveforms 2000 illustrating the resynchronization time of PLL 1802 after a change in operating frequency, according to an embodiment of the present invention. As shown in FIG. 20, in some embodiments, by using PLL 1802 with increasing dead-times when synchronization is lost, the resynchronization time t_{resynch} between a change in operating frequency of wireless power transmitter 204 (t₂₀) and full resynchronization (t₂₁) may be less than 1.5 ms, and the time t₂₂ between time t₂₀ and current I_{RX} reaching the steady state peak values may be less than 350 μs.

Example embodiments of the present invention are summarized here. Other embodiments can also be understood from the entirety of the specification and the claims filed herein.

Example 1. A method for transmitting data from a wireless power receiver to a wireless power transmitter, the method including: wirelessly receiving power with a receiver resonant tank of the wireless power receiver from a transmitting coil of the wireless power transmitter; rectifying a receiver voltage received from the receiver resonant tank by switching first and second legs of a synchronous rectifier circuit based on a zero-crossing of a receiver current flowing through the receiver resonant tank to produce a rectified voltage; and while wirelessly receiving power with the receiver resonant tank, encoding data by causing transitions in a transmitter current flowing through the transmitting coil using the synchronous rectifier circuit, where encoding the data includes: applying a first sudden delay period in a first direction to a first switching of the first and second legs to cause a transition in the transmitter current; and after the first switching of the first and second legs, applying a first gradual delay in the first direction to subsequent switching of the first and second legs, where the first gradual delay is gradually incremented by a gradual increment period that is smaller than the first sudden delay period.

Example 2. The method of example 1, where the transition of the transmitter current includes a change of at least 15 mA in a 100 μs period.

Example 3. The method of one of examples 1 or 2, where the first sudden delay period is a time period between 10 ns and 500 ns.

Example 4. The method of one of examples 1 to 3, where the wireless power receiver does not have a capacitor bank connected to an intermediate node, the intermediate node coupled between the receiver resonant tank and the synchronous rectifier circuit.

Example 5. The method of one of examples 1 to 4, where the first leg includes first and second transistors, where the second leg includes third and fourth transistors, and where switching the first and second legs includes: when the first and third transistors are on and the second and fourth transistors are off, turning off the first and third transistors and turning on the second and fourth transistors during a zero-crossing of the receiver current; and when the second and fourth transistors are on and the first and third transistors are off, turning off the second and fourth transistors and turning on the first and third transistors during a zero-crossing of the receiver current.

Example 6. The method of one of examples 1 to 5, where the gradual increment period is constant.

Example 7. The method of one of examples 1 to 6, where the gradual increment period is based on the rectified voltage.

Example 8. The method of one of examples 1 to 7, where applying the first gradual delay in the first direction to subsequent switching of the first and second legs causes a root-mean-square (RMS) value of the rectified voltage to change at a constant rate.

Example 9. The method of one of examples 1 to 8, where applying the first sudden delay period in the first direction includes delaying the switching of the first and second legs with respect to the receiver current.

Example 10. The method of one of examples 1 to 9, where applying the first sudden delay period in the first direction includes advancing the switching of the first and second legs with respect to the receiver current.

Example 11. The method of one of examples 1 to 10, where applying the first sudden delay period in the first direction includes delaying the switching of the second leg with respect to the first leg.

Example 12. The method of one of examples 1 to 11, where applying the first sudden delay period in the first direction includes advancing the switching of the second leg with respect to the first leg.

Example 13. The method of one of examples 1 to 12, where the first switching is associated with a start bit of a data packet to be transmitted from the wireless power receiver to the wireless power transmitter.

Example 14. The method of one of examples 1 to 13, where the start bit of the data packet is a first bit of a preamble of a data packet.

Example 15. The method of one of examples 1 to 14, where encoding the data includes encoding the data in accordance with Qi standard.

Example 16. The method of one of examples 1 to 15, where encoding the data further includes: applying a second sudden delay period in a second direction to a further switching of the first and second legs to cause a further transition in the transmitter current, the second direction being opposite the first direction; and after the further switching of the first and second legs, applying a second delay in the second direction to subsequent switching of the first and second legs, where the second delay is gradually incremented by a second gradual increment period that is smaller than the second sudden delay period.

Example 17. The method of one of examples 1 to 16, where encoding the data further includes alternating application of the first sudden delay period and the second sudden delay period while switching first and second legs during a data transmission period.

Example 18. The method of one of examples 1 to 17, where causing transitions in the transmitter current includes causing transitions in the transmitter current at a frequency between 1 kHz and 2 kHz.

Example 19. A method for transmitting data from a wireless power receiver to a wireless power transmitter, the method including: wirelessly receiving power with a receiver resonant tank of the wireless power receiver from a transmitting coil of the wireless power transmitter; rectifying a receiver voltage received from the receiver resonant tank by switching first and second legs of a synchronous rectifier circuit based on a zero-crossing of a receiver current flowing through the receiver resonant tank to produce a rectified voltage, where the first leg includes first and second transistors, and where the second leg includes third and fourth transistors; and while wirelessly receiving power with the receiver resonant tank, encoding data by causing transitions in a transmitter current flowing through the transmitting coil using the synchronous rectifier circuit, where encoding the data includes: turning off the first, second, third and fourth transistors for a first sudden period during a first switching cycle of the first and second legs to cause a transition in the transmitter current; and after the first switching cycle, turning off the first, second, third and fourth transistors for a first gradual period during subsequent switching cycles of the first and second legs, where the first gradual period is gradually incremented by a gradual increment period that is smaller than the first sudden period.

Example 20. The method of example 19, where the transition of the transmitter current includes a change of at least 15 mA in a 100 μs period.

Example 21. The method of one of examples 19 or 20, where the first sudden period is a time period between 10 ns and 500 ns.

Example 22. The method of one of examples 19 to 21, where the wireless power receiver does not have a capacitor bank connected to an intermediate node, the intermediate node coupled between the receiver resonant tank and the synchronous rectifier circuit.

Example 23. The method of one of examples 19 to 22, where switching the first and second legs includes: when the first and third transistors are on and the second and fourth transistors are off, turning off the first and third transistors and turning on the second and fourth transistors during a zero-crossing of a receiver current flowing through the receiver resonant tank; and when the second and fourth transistors are on and the first and third transistors are off, turning off the second and fourth transistors and turning on the first and third transistors during a zero-crossing of the receiver current.

Example 24. The method of one of examples 19 to 23, where the gradual increment period is constant.

Example 25. The method of one of examples 19 to 24, where the gradual increment period is based on the rectified voltage.

Example 26. The method of one of examples 19 to 25, where turning off the first, second, third and fourth transistors for the first gradual period during subsequent switching cycles of the first and second legs causes a root-mean-square (RMS) value of the rectified voltage to change at a constant rate.

Example 27. The method of one of examples 19 to 26, where the first switching cycle is associated with a start bit of a data byte to be transmitted from the wireless power receiver to the wireless power transmitter.

Example 28. The method of one of examples 19 to 27, where encoding the data includes encoding the data in accordance with Qi standard.

Example 29. The method of one of examples 19 to 28, where causing transitions in the transmitter current includes causing transitions in the transmitter current at a frequency between 1 kHz and 2 kHz.

Example 30. The method of one of examples 19 to 29, where a zero-crossing of the receiver current occurs during the first sudden period.

Example 31. The method of one of examples 19 to 30, where a peak of the receiver current occurs during the first sudden period.

Example 32. A method for regulating a rectified voltage, the method including: wirelessly receiving power with a receiver resonant tank of a wireless power receiver from a transmitting coil of a wireless power transmitter; rectifying a receiver voltage received from the receiver resonant tank by switching first and second legs of a synchronous rectifier circuit based on a zero-crossing of a receiver current flowing through the receiver resonant tank to produce the rectified voltage; and while wirelessly receiving power with the receiver resonant tank, adjusting a phase angle between the first and second legs and the zero-crossing of the receiver current, or between the first and second legs, to regulate the rectified voltage at a target voltage.

Example 33. The method of example 32, where adjusting the phase angle includes: when the rectified voltage is below the target voltage, increasing the phase angle between the first and second legs and the zero-crossing of the receiver current to increase the rectified voltage towards the target voltage; and when the rectified voltage is above the target voltage, decreasing the phase angle between the first and second legs and the zero-crossing of the receiver current to decrease the rectified voltage towards the target voltage.

Example 34. The method of one of examples 32 or 33, where adjusting the phase angle includes: when the rectified voltage is below the target voltage, increasing the phase angle between the first and second legs to increase the rectified voltage towards the target voltage; and when the rectified voltage is above the target voltage, decreasing the phase angle between the first and second legs to decrease the rectified voltage towards the target voltage.

Example 35. The method of one of examples 32 to 34, where adjusting the phase angle includes adjusting the phase angle between the first and second legs and the zero-crossing of the receiver current, or between the first and second legs, in a range that is between −30° and 30°.

Example 36. The method of one of examples 32 to 35, further including, when the phase angle between the first and second legs and the zero-crossing of the receiver current, or between the first and second legs, is above a first predetermined phase angle or below a second predetermined phase angle, transmitting a request to the wireless power transmitter to change a level of transmitted power.

Example 37. The method of one of examples 32 to 36, where the first predetermined phase angle is between −5° and 30°, and where the second predetermined phase angle is between 5° and 30°.

Example 38. The method of one of examples 32 to 37, where transmitting the request to the wireless power transmitter includes transmitting the request via the receiver resonant tank.

Example 39. The method of one of examples 32 to 38, further including negotiating, between the wireless power receiver and the wireless power transmitter, a level of transmitted power, where adjusting the phase angle between the first and second legs and the zero-crossing of the receiver current, or between the first and second legs, to regulate the rectified voltage at the target voltage is performed after the negotiation.

Example 40. The method of one of examples 32 to 39, further including, after the negotiation and before adjusting the phase angle between the first and second legs and the zero-crossing of the receiver current, or between the first and second legs, switching, for a first period of time, the first and second legs with a phase angle of zero between the first and second legs and the zero-crossing of the receiver current, and with a phase angle of zero between the first and second legs.

Example 41. The method of one of examples 32 to 40, where the first period of time is less than 1 second.

Example 42. The method of one of examples 32 to 41, where the first period of time is determined based on the rectified voltage.

Example 43. The method of one of examples 32 to 42, where adjusting the phase angle between the first and second legs and the zero-crossing of the receiver current, or between the first and second legs, to regulate the rectified voltage at a target voltage includes adjusting the phase angle between the first and second legs and the zero-crossing of the receiver current, or between the first and second legs, when the rectified voltage is above a first predetermined voltage or below a second predetermined voltage.

Example 44. The method of one of examples 32 to 43, further including, when the rectified voltage is above a first predetermined voltage or below a second predetermined voltage, transmitting a request to the wireless power transmitter to change a level of transmitted power.

Example 45. The method of one of examples 32 to 44, further including regulating a transmitter current flowing through the transmitting coil to a target current.

Example 46. The method of one of examples 32 to 45, further including, determining the target current based on the transmitter current flowing through the transmitting coil when the first and second legs are switching with a phase angle of zero with respect to each other and with a phase angle of zero with respect to the zero-crossing of the receiver current.

Example 47. The method of one of examples 32 to 46, further including begin regulating the transmitter current when the transmitter current is below a first current threshold or above a second current threshold.

Example 48. The method of one of examples 32 to 47, further including generating a reference timing signal with a phase-locked loop (PLL) coupled to the synchronous rectifier circuit, and where switching the first and second legs includes switching the first and second legs based on an output of the PLL.

Example 49. The method of one of examples 32 to 48, further including: detecting, with a forward diode conduction detector, when a given transistor of the first or second leg is in forward diode conduction mode; detecting, with a zero-crossing detector, a zero-crossing of the receiver current; and controlling the PLL based on an output of the forward diode conduction detector and based on an output of the zero-crossing detector.

Example 50. The method of one of examples 32 to 49, where a flip-flop has a first input coupled to the output of the forward diode conduction detector, a second input coupled to the output of the zero-crossing detector, and an output coupled to the PLL.

Example 51. The method of one of examples 32 to 50, where adjusting the phase angle between the first and second legs and the zero-crossing of the receiver current, or between the first and second legs, includes adjusting the phase angle of a switching of one leg of the first and second legs with respect to the output of the PLL.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for transmitting data from a wireless power receiver to a wireless power transmitter, the method comprising:
wirelessly receiving power with a receiver resonant tank of the wireless power receiver from a transmitting coil of the wireless power transmitter;
rectifying a receiver voltage received from the receiver resonant tank by switching first and second legs of a synchronous rectifier circuit based on a zero-crossing of a receiver current flowing through the receiver resonant tank to produce a rectified voltage; and
while wirelessly receiving power with the receiver resonant tank, encoding data by causing transitions in a transmitter current flowing through the transmitting coil using the synchronous rectifier circuit, wherein encoding the data comprises:
applying a first sudden delay period in a first direction to a first switching of the first and second legs to cause a transition in the transmitter current; and
after the first switching of the first and second legs, applying a first gradual delay in the first direction to subsequent switching of the first and second legs, wherein the first gradual delay is gradually incremented by a gradual increment period that is smaller than the first sudden delay period.

2. The method of claim 1, wherein the transition of the transmitter current comprises a change of at least 15 mA in a 100 μs period.

3. The method of claim 1, wherein the first sudden delay period is a time period between 10 ns and 500 ns.

4. The method of claim 1, wherein the wireless power receiver does not have a capacitor bank connected to an intermediate node, the intermediate node coupled between the receiver resonant tank and the synchronous rectifier circuit.

5. The method of claim 1, wherein the first leg comprises first and second transistors, wherein the second leg comprises third and fourth transistors, and wherein switching the first and second legs comprises:
when the first and third transistors are on and the second and fourth transistors are off, turning off the first and third transistors and turning on the second and fourth transistors during a zero-crossing of the receiver current; and
when the second and fourth transistors are on and the first and third transistors are off, turning off the second and fourth transistors and turning on the first and third transistors during a zero-crossing of the receiver current.

6. The method of claim 1, wherein the gradual increment period is constant.

7. The method of claim 1, wherein the gradual increment period is based on the rectified voltage.

8. The method of claim 1, wherein applying the first gradual delay in the first direction to subsequent switching of the first and second legs causes a root-mean-square (RMS) value of the rectified voltage to change at a constant rate.

9. The method of claim 1, wherein applying the first sudden delay period in the first direction comprises delaying the switching of the first and second legs with respect to the receiver current.

10. The method of claim 1, wherein applying the first sudden delay period in the first direction comprises advancing the switching of the first and second legs with respect to the receiver current.

11. The method of claim 1, wherein applying the first sudden delay period in the first direction comprises delaying the switching of the second leg with respect to the first leg.

12. The method of claim 1, wherein applying the first sudden delay period in the first direction comprises advancing the switching of the second leg with respect to the first leg.

13. The method of claim 1, wherein the first switching is associated with a start bit of a data packet to be transmitted from the wireless power receiver to the wireless power transmitter.

14. The method of claim 13, wherein the start bit of the data packet is a first bit of a preamble of a data packet.

15. The method of claim 1, wherein encoding the data comprises encoding the data in accordance with Qi standard.

16. The method of claim 1, wherein encoding the data further comprises:
applying a second sudden delay period in a second direction to a further switching of the first and second legs to cause a further transition in the transmitter current, the second direction being opposite the first direction; and
after the further switching of the first and second legs, applying a second delay in the second direction to subsequent switching of the first and second legs, wherein the second delay is gradually incremented by a second gradual increment period that is smaller than the second sudden delay period.

17. The method of claim 16, wherein encoding the data further comprises alternating application of the first sudden delay period and the second sudden delay period while switching first and second legs during a data transmission period.

18. The method of claim 1, wherein causing transitions in the transmitter current comprises causing transitions in the transmitter current at a frequency between 1 kHz and 2 kHz.

19. A method for transmitting data from a wireless power receiver to a wireless power transmitter, the method comprising:
wirelessly receiving power with a receiver resonant tank of the wireless power receiver from a transmitting coil of the wireless power transmitter;
rectifying a receiver voltage received from the receiver resonant tank by switching first and second legs of a synchronous rectifier circuit based on a zero-crossing of a receiver current flowing through the receiver resonant tank to produce a rectified voltage, wherein the first leg comprises first and second transistors, and wherein the second leg comprises third and fourth transistors; and
while wirelessly receiving power with the receiver resonant tank, encoding data by causing transitions in a transmitter current flowing through the transmitting coil using the synchronous rectifier circuit, wherein encoding the data comprises:
turning off the first, second, third and fourth transistors for a first sudden period during a first switching cycle of the first and second legs to cause a transition in the transmitter current; and
after the first switching cycle, turning off the first, second, third and fourth transistors for a first gradual period during subsequent switching cycles of the first and second legs, wherein the first gradual period is gradually incremented by a gradual increment period that is smaller than the first sudden period.

20. The method of claim 19, wherein the transition of the transmitter current comprises a change of at least 15 mA in a 100 μs period.

21. The method of claim 19, wherein the first sudden period is a time period between 10 ns and 500 ns.

22. The method of claim 19, wherein the wireless power receiver does not have a capacitor bank connected to an intermediate node, the intermediate node coupled between the receiver resonant tank and the synchronous rectifier circuit.

23. The method of claim 19, wherein switching the first and second legs comprises:
when the first and third transistors are on and the second and fourth transistors are off, turning off the first and third transistors and turning on the second and fourth transistors during a zero-crossing of a receiver current flowing through the receiver resonant tank; and
when the second and fourth transistors are on and the first and third transistors are off, turning off the second and fourth transistors and turning on the first and third transistors during a zero-crossing of the receiver current.

24. The method of claim 19, wherein the gradual increment period is constant.

25. The method of claim 19, wherein the gradual increment period is based on the rectified voltage.

26. The method of claim 19, wherein turning off the first, second, third and fourth transistors for the first gradual period during subsequent switching cycles of the first and second legs causes a root-mean-square (RMS) value of the rectified voltage to change at a constant rate.

27. The method of claim 19, wherein the first switching cycle is associated with a start bit of a data byte to be transmitted from the wireless power receiver to the wireless power transmitter.

28. The method of claim 19, wherein encoding the data comprises encoding the data in accordance with Qi standard.

29. The method of claim 19, wherein causing transitions in the transmitter current comprises causing transitions in the transmitter current at a frequency between 1 kHz and 2 kHz.

30. The method of claim 19, wherein a zero-crossing of the receiver current occurs during the first sudden period.

31. The method of claim 19, wherein a peak of the receiver current occurs during the first sudden period.

32. A method for regulating a rectified voltage, the method comprising:
wirelessly receiving power with a receiver resonant tank of a wireless power receiver from a transmitting coil of a wireless power transmitter;
rectifying a receiver voltage received from the receiver resonant tank by switching first and second legs of a synchronous rectifier circuit based on a zero-crossing of a receiver current flowing through the receiver resonant tank to produce the rectified voltage; and
while wirelessly receiving power with the receiver resonant tank, adjusting a phase angle between the first and second legs and the zero-crossing of the receiver current, or between the first and second legs, to regulate the rectified voltage at a target voltage.

33. The method of claim 32, wherein adjusting the phase angle comprises:
when the rectified voltage is below the target voltage, increasing the phase angle between the first and second legs and the zero-crossing of the receiver current to increase the rectified voltage towards the target voltage; and
when the rectified voltage is above the target voltage, decreasing the phase angle between the first and second legs and the zero-crossing of the receiver current to decrease the rectified voltage towards the target voltage.

34. The method of claim 32, wherein adjusting the phase angle comprises:
when the rectified voltage is below the target voltage, increasing the phase angle between the first and second legs to increase the rectified voltage towards the target voltage; and
when the rectified voltage is above the target voltage, decreasing the phase angle between the first and second legs to decrease the rectified voltage towards the target voltage.

35. The method of claim 32, wherein adjusting the phase angle comprises adjusting the phase angle between the first and second legs and the zero-crossing of the receiver current, or between the first and second legs, in a range that is between −30° and 30°.

36. The method of claim 32, further comprising, when the phase angle between the first and second legs and the zero-crossing of the receiver current, or between the first and second legs, is above a first predetermined phase angle or below a second predetermined phase angle, transmitting a request to the wireless power transmitter to change a level of transmitted power.

37. The method of claim 36, wherein the first predetermined phase angle is between −5° and 30°, and wherein the second predetermined phase angle is between 5° and 30°.

38. The method of claim 36, wherein transmitting the request to the wireless power transmitter comprises transmitting the request via the receiver resonant tank.

39. The method of claim 32, further comprising negotiating, between the wireless power receiver and the wireless power transmitter, a level of transmitted power, wherein adjusting the phase angle between the first and second legs and the zero-crossing of the receiver current, or between the first and second legs, to regulate the rectified voltage at the target voltage is performed after the negotiation.

40. The method of claim 39 , further comprising, after the negotiation and before adjusting the phase angle between the first and second legs and the zero-crossing of the receiver current, or between the first and second legs, switching, for a first period of time, the first and second legs with a phase angle of zero between the first and second legs and the zero-crossing of the receiver current, and with a phase angle of zero between the first and second legs.

41. The method of claim 40, wherein the first period of time is less than 1 second.

42. The method of claim 40, wherein the first period of time is determined based on the rectified voltage.

43. The method of claim 42, wherein adjusting the phase angle between the first and second legs and the zero-crossing of the receiver current, or between the first and second legs, to regulate the rectified voltage at a target voltage comprises adjusting the phase angle between the first and second legs and the zero-crossing of the receiver current, or between the first and second legs, when the rectified voltage is above a first predetermined voltage or below a second predetermined voltage.

44. The method of claim 32, further comprising, when the rectified voltage is above a first predetermined voltage or below a second predetermined voltage, transmitting a request to the wireless power transmitter to change a level of transmitted power.

45. The method of claim 32, further comprising regulating a transmitter current flowing through the transmitting coil to a target current.

46. The method of claim 45, further comprising, determining the target current based on the transmitter current flowing through the transmitting coil when the first and second legs are switching with a phase angle of zero with respect to each other and with a phase angle of zero with respect to the zero-crossing of the receiver current.

47. The method of claim 45, further comprising begin regulating the transmitter current when the transmitter current is below a first current threshold or above a second current threshold.

48. The method of claim 32, further comprising generating a reference timing signal with a phase-locked loop (PLL) coupled to the synchronous rectifier circuit, and wherein switching the first and second legs comprises switching the first and second legs based on an output of the PLL.

49. The method of claim 48, further comprising:
detecting, with a forward diode conduction detector, when a given transistor of the first or second leg is in forward diode conduction mode;
detecting, with a zero-crossing detector, a zero-crossing of the receiver current; and
controlling the PLL based on an output of the forward diode conduction detector and based on an output of the zero-crossing detector.

50. The method of claim 49, wherein a flip-flop has a first input coupled to the output of the forward diode conduction detector, a second input coupled to the output of the zero-crossing detector, and an output coupled to the PLL.

51. The method of claim 48, wherein adjusting the phase angle between the first and second legs and the zero-crossing of the receiver current, or between the first and second legs, comprises adjusting the phase angle of a switching of one leg of the first and second legs with respect to the output of the PLL.
